(19) United States
(12) Patent Application Publication
(10) Pub. No.: US 2023/0230075 A1
(43) Pub. Date: Jul. 20, 2023

(54) LONGITUDINAL SYSTEM USING NON-FUNGIBLE TOKENS THAT EVOLVE OVER TIME

(71) Applicant: Live Nation Entertainment, Inc., Beverly Hills, CA (US)

(72) Inventors: Joseph P. Aiello, Old Hickory, TN (US); Ashish Ravindra Gupta, Los Angeles, CA (US); Alanna Blythe Kitaeff, Santa Monica, CA (US); Brendan Michael Lynch, Manhattan Beach, CA (US); Christopher James Tweed-Kent, Los Angeles, CA (US)

(73) Assignee: Live Nation Entertainment, Inc., Beverly Hills, CA (US)

(21) Appl. No.: 18/157,004

(22) Filed: Jan. 19, 2023

Related U.S. Application Data
(60) Provisional application No. 63/300,980, filed on Jan. 19, 2022.

(51) Int. Cl. G06Q 20/38; G06Q 20/40; G06Q 20/36

(52) U.S. Cl. CPC G06Q 20/38215; G06Q 20/4014; G06Q 20/389; G06Q 20/3674

(57) ABSTRACT

Certain embodiments of the present disclosure relate to a system and method for the assignment of access rights and an NFT to a user device. The method includes assigning a non-fungible token (NFT), linked with the access rights, to the account associated with the user device based on the assignment of the access rights from the list of unfilled access rights. The method further includes verifying the validity of the access rights linked with the NFT, when the user device is requesting access to the resource, based on scanning information provided on the access rights and referencing a transaction history of the NFT in the blockchain, and transmitting at least one updated NFT and privilege to access the resource to the user device based on the verification of the access rights linked with the NFT.

This application is a non-provisional of and claims priority to Provisional Application Ser. No. 63/300,980 filed on Jan. 19, 2022, which is incorporated herein by reference for all purposes.

### BACKGROUND

This disclosure relates in general to allocating tickets for a live event inside a venue and, by no way of limitation, to allocating non-fungible tokens along with tickets amongst other things.

Events inside venues have happened since the beginning of time. Venues are equipped with modern technology that enables users to watch events or shows remotely on their television sets or handheld devices in real time. There are some people who prefer to watch sporting events on their television sets rather than live. This creates a bad experience for competitors inside the venue as they miss their fans. As fewer people travel to the venue, the cost of maintaining the venue may not be recouped. Thus, there is a requisite to encourage fans to watch events inside the venues.

### SUMMARY

In one embodiment, the present disclosure provides one or more techniques for using Non-Fungible Tokens (NFTs) inside a venue. The NFTs are allocated to a user at the time of purchase of tickets, which can be used to authenticate the user while entering the venue. More NFTs are allocated to users as the users interact inside the venue. Since NFTs have a value associated with them, users can buy/sell/trade NFTs. Thus, users are encouraged to interact more inside the venue so as to collect more and more NFTs.

In another embodiment, the present disclosure provides techniques for purchasing tickets for a live event. The techniques comprise receiving a request for tickets from a user, extracting details, for example, but not limited to, seats from the ticket, wherein the details comprise a type of seats desired by the user, assigning the tickets to the user based on the type of seats desired by the user, assigning a non-fungible token to the user along with the ticket, and transmitting a confirmation of the ticket and the non-fungible token to the user.

In another embodiment, the present disclosure provides techniques for reading tickets at a venue. The techniques comprise scanning tickets at an entrance of the venue, verifying tickets and non-fungible tokens at the entrance of the venue, wherein the non-fungible tokens (NFTs) are assigned to the user along with the purchase of the tickets, permitting access to the user in the venue if the verification of the tickets and the non-fungible tokens are successful, and assigning another NFT to the user if the verification of the tickets and the non-fungible tokens are successful.

In another embodiment, the present disclosure provides techniques for monitoring interactions of a user inside a venue. The techniques comprise monitoring in-venue purchases of the user, wherein when the in-venue purchase occurs, assigning a non-fungible token to the user, and when the in-venue purchase does not occur, transmitting promotional offers to user to encourage the user to make more purchases inside the venue.

In yet another embodiment, the present disclosure provides techniques for recommending activities to a user. The techniques comprise reading ticket and NFT credentials an entrance to the venue, verifying authenticity of the user based on reading of ticket and NFT credentials, and monitoring the past and present behavior of the user if the ticket and NFT credentials are valid, and recommending future activities to the user based on behavior of the user.

In yet another embodiment, the present disclosure provides techniques for prioritizing users inside a venue. The techniques comprise identifying number of tickets available inside the venue, identifying number of NFTs available with the users if the number of tickets is less than a threshold, and prioritizing users based on the number of NFTs.

In yet another embodiment, the present disclosure provides techniques for providing rewards to the user inside a venue. The techniques comprise monitoring interactions of the user inside the venue, identifying number of transactions made by the user inside the venue based on the number of interactions, assigning scores to users based on the number of transactions made by the user, and providing rewards to users based on scores of the users.

In yet another embodiment, the present disclosure provides techniques for creating NFTs inside a venue. The techniques comprise capturing media inside the venue, wherein the media comprises images and videos, uploading media to a server for approval by moderator, creating NFT using media based if the media is approved by the moderator and trading NFTs between different users created by the user.

Certain embodiments of the present disclosure relate to a method for assignment of access rights, to access a resource for a defined period of time, to at least one user device, the method comprising: rendering, via a credential server, first information associated with the resource to the user device, and receiving a request for access rights from the at least one user device in response to the rendered first information, wherein the request includes at least one of a location associated with the resource and a number of access rights requested by the user device. The method also includes extracting information from a first database based on the request received from the user device, wherein the extracted information includes a list of the unfilled number of access rights requested by the user device with parameters including at least one of the locations associated with the resource, a type of access rights requested by the user device, and identifiers associated with the access rights, and assigning, via the credential server, access rights, from the list of unfilled access rights to an account associated with the user device based on the received request.

Further, the method also includes assigning, by the credential server, a non-fungible token (NFT), linked with the access rights, to the account associated with the user device based on the assignment of the access rights from the list of unfilled access rights, wherein NFT is a non-fungible token in a blockchain, and acquiring, by the credential server, personal identification information of the account associated with the user device, updating the blockchain and the first database in response to the acquired personal identification information associated with the user device, and transmitting a notification to the user device, wherein the notification comprises a confirmation of assignment of the access rights and the NFT to the account associated with the user device.

The method further includes verifying validity of the access rights linked with the NFT, when the user device is requesting access to the resource, based on scanning information provided on the access rights and referencing a transaction history of the NFT in the blockchain, and transmitting at least one updated NFT and privilege to access the resource to the user device based on the verification of the access rights linked with the NFT.

Additionally, certain embodiments of the present disclosure relate to a computer-program product tangibly embodied in a non-transitory machine-readable storage medium, including instructions configured to cause a data processing apparatus to perform operations, for the assignment of access rights, to access a resource for a defined period of time, to at least one user device, including rendering, via a credential server, first information associated with the resource to the user device, and receiving a request for access rights from the at least one user device in response to the rendered first information, wherein the request includes at least one of a location associated with the resource and a number of access rights requested by the user device. The method also includes extracting information from a first database based on the request received from the user device, wherein the extracted information includes a list of the unfilled number of access rights requested by the user device with parameters including at least one of the locations associated with the resource, a type of access rights requested by the user device, and identifiers associated with the access rights, and assigning, via the credential server, access rights, from the list of unfilled access rights to an account associated with the user device based on the received request. Further, the method also includes assigning, by the credential server, a non-fungible token (NFT), linked with the access rights, to the account associated with the user device based on the assignment of the access rights from the list of unfilled access rights, wherein NFT is a non-fungible token in a blockchain, and acquiring, by the credential server, personal identification information of the account associated with the user device, updating the blockchain and the first database in response to the acquired personal identification information associated with the user device, and transmitting a notification to the user device, wherein the notification comprises a confirmation of assignment of the access rights and the NFT to the account associated with the user device. The method further includes verifying the validity of the access rights linked with the NFT, when the user device is requesting access to the resource, based on scanning information provided on the access rights and referencing a transaction history of the NFT in the blockchain, and transmitting at least one updated NFT and privilege to access the resource to the user device based on the verification of the access rights linked with the NFT.

In yet another embodiment, the method may further include transferring ownership of the NFT linked with access rights based on the information of a second user who is a receiving destination. Additionally, transferring the ownership of the NFT includes whether to give privilege related to the transfer of the ownership to a user, associated with the user device, who is at the receiving destination, and the second user is eligible as a receiving destination based on a participation score of accessing the resource or based on an index value associated with a social medial ID of the second user as an action history of the second user.

In yet another embodiment, the method may further include prioritizing the user devices for accessing privileges or other access rights based on NFTs owned by a user, associated with the user device, and past history stored in the first database.

In yet another embodiment, the method may further include the first information including presale notifications to be transmitted to one or more user devices selected from a whitelist stored in the first database.

In yet another embodiment, the method may further include comprising generating the whitelist that includes a list of approved user devices based on a comparison of the personal identification information associated with one or more user devices with corresponding information stored in the first database.

In yet another embodiment, the method may further include the first database storing at least one of historical data associated with the user devices, user preferences, user behavior, location information associated with the user device, a list of available access rights, the NFT assigned to the user device, and social media account information associated with the user device.

In yet another embodiment, the method may further include managing the personal identification information and the NFT assigned to the user device using the blockchain.

In yet another embodiment, the method may further include verifying the personal identification information acquired by the credential server by comparing it with the personal identification information registered in the first database.

In yet another embodiment, the method may further include rendering the access rights associated with the NFT to the user device based on the verification of the identity of a user, associated with a user device, registered in advance, and wherein the verified information is stored in the first database.

In yet another embodiment, the method may further include the NFT issued in the blockchain in which nodes permitted by an administrator can participate, and wherein the NFTs are stored either in a non-custodial wallet accessible on the user device or in a custodial wallet accessible to NFT issuer.

In yet another embodiment, the method may further include defining a transfer method of the access rights linked to the NFT based on a smart contract of the blockchain, wherein the transfer method defines an identifier at which the user device circulates the access rights.

In yet another embodiment, the method may further include transmitting the access rights to a user, via the credential server, based on referencing a transaction history of the NFT in the blockchain and verifying the transaction history in accordance with one or more rules of a ticket transfer method linked to the NFT.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of a system according to an embodiment of the present disclosure;

FIG. 2 illustrates a block diagram of a venue management device according to an embodiment of the present disclosure;

FIG. 3 illustrates a block diagram of a server according to an embodiment of the present disclosure;

FIG. 4 illustrates a block diagram of an end-user device according to an embodiment of the present disclosure;

FIG. 5 illustrates a process flow inside a venue according to an embodiment of the present disclosure;

FIG. 6 illustrates a flowchart of processes for allocating tickets to a user according to an embodiment of the present disclosure;

FIG. 7 illustrates a flowchart of processes for entering a user inside a venue, according to an embodiment of the present disclosure;

FIG. 8 illustrates a flowchart of processes for improving the in-venue experience of a user in accordance with an embodiment of the present disclosure;

FIG. 9 illustrates a flowchart of processes for recommending activities to a user in accordance with an embodiment of the present disclosure;

FIG. 10 illustrates a flowchart of processes for prioritizing users for purchasing tickets in accordance with an embodiment of the present disclosure;

FIG. 11 illustrates a flowchart of processes for providing rewards to users inside a venue in accordance with an embodiment of the present disclosure;

FIG. 12 illustrates a flowchart of processes for creating NFTs by users inside a venue in accordance with an embodiment of the present disclosure;

FIG. 13 illustrates an example embodiment of an NFT according to an embodiment of the present disclosure;

FIG. 14 illustrates an example embodiment of an NFT according to another embodiment of the present disclosure;

FIG. 15 illustrates an example embodiment of an NFT based engagement of users according to another embodiment of the present disclosure;

FIG. 16 illustrates an example embodiment of process flow of assigning credentials linked with NFT according to another embodiment of the present disclosure;

FIG. 17A illustrates an example embodiment of an event with audience attending the event according to another embodiment of the present disclosure;

FIG. 17B illustrates an example embodiment of creating giant artwork using NFTs according to another embodiment of the present disclosure;

FIG. 18A illustrates an example embodiment of front side of credentials according to another embodiment of the present disclosure; and

FIG. 18B illustrates an example embodiment of the rear side of credentials according to another embodiment of the present disclosure.

FIG. 19 illustrates an example flowchart of verification of the access rights using NFC technology.

FIG. 20 illustrates an example flowchart of Access rights verification and updating NFTs using NFC technology.

In the appended figures, similar components and/or features may have the same reference label. Further, various components of the same type maybe distinguished by following the reference label with a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

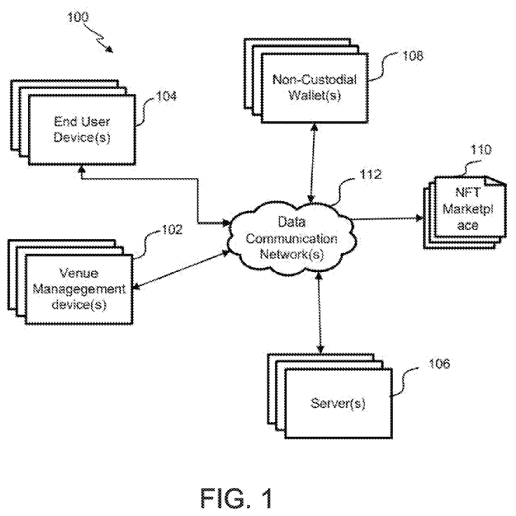

FIG. 1, depicts a block diagram of an event management system 100, according to some embodiment of the present disclosure. The event management system 100 comprises a plurality of venue management device(s) 102, a plurality of end user device(s) 104, a plurality of server(s) 106, a plurality of non-custodial wallet(s) 108, and a plurality of web interfaces for NFT marketplace 110. Different components of the event management system 100 are connected via a data communication network(s) 112. The data communication network(s) 112 can provide a wireless connection with other components.

The plurality of venue management device(s) 102 can be operated by one or more event providers hosting a live event at a venue. The venue management device(s) 102 can generate and/or transmit event-provider communication. For example, the venue management device(s) 102 can send an event provider communication that indicates Location Y in New York, and will host a series of periods (e.g., a series of the play Hamilton on 10 particular nights). In one embodiment, an individual location associated with a single series of periods is identified from the event provider communication. For example, the received event provider communication indicate a location of Location Y for hosting a single series of Hamilton shows between March 2018 and April 2018. In another embodiment, the received event provider communication can indicate multiple locations associated with multiple series of periods. For example, the received event provider communication can indicate Location Y for hosting a series of Hamilton shows between March 2018 and April 2018 and the location Raleigh Arena in Raleigh, N.C. for hosting a series of Hamilton shows between June 2018 and July 2018. As can be seen, a series of periods can correspond to a series of events of a particular performance or show at a particular venue (e.g., location). In such an embodiment, each performance can occur at a particular location at a particular period.

The plurality of end user device(s) 104 can be used to request the assignment of tickets from the event providers. The plurality of end user device(s) 104 can be any type of computing device that is portable, e.g., smartphones, mobile phones, tablets, and/or other similar devices. Each user (or fan) attending an event inside the venue can carry an end user device(s) 104 with them inside the venue. A plurality of activities can be performed with the help of the end user device(s) 104, for example, but not limited, carrying a ticket in digital form for the event, entering inside the venue using the digital ticket present on an application running on the end user device(s) 104, making purchases inside the venue using the end user device(s) 104.

The server(s) 106 can rely on a blockchain-based computing platform that distinguishes itself from the Bitcoin blockchain by enabling “smart contract” functionality. An example of such a blockchain-based computing platform is Ethereum™. In some cases, the computing platform provides a decentralized virtual machine that executes peer-to-peer contracts using cryptocurrency. These contracts are applications that run unerringly as programmed without any possibility of downtime, censorship, fraud, or third-party interference. They can operate on this blockchain (“the blockchain”), a powerful shared global infrastructure that can move value around and represent the ownership of property. This generally enables developers to create markets, store registries of debts or promises, move funds in accordance with instructions given long in the past (like a will or a futures contract), and many other things that have not been developed yet, without a middle-man or counterparty risk.

Each ticket for the venue can undergo a tokenization and securitization process, which includes the obfuscation of the barcode that is entailed for entry. The barcode can not include any identifying information of an owner of a ticket. Every ticket can have a set of principals who have different levels of access to the ticket, similar to authorization roles in operating system security (i.e., Administrators, Super Users, Users, and Guests). The ticket issuer, the ticket administrator (in this case, the party associated with the system), and the ticket owner each can have the authorization to perform various transactions on the ticket. Meanwhile, “guest” users can access information such as the ticket, including confirming ownership of the ticket to build trust in a potential transaction.

Each ticket can be authenticated by ticket credentials and Non-fungible tokens (NFT) which can be allocated to a user at the time of purchasing the ticket. The NFTs are exclusive and non-interchangeable units of data stored on a digital ledger (blockchain). NFTs can be associated with easily-reproducible items such as photos, videos, audio, and other types of digital files as exclusive items (analogous to a certificate of authenticity). NFTs use blockchain technology to provide public proof of ownership.

Further, a user can purchase or trade NFTs during the event. The plurality of web interfaces for the NFT marketplace 110 comprises the NFTs available to the user for purchasing or trading NFTs. The NFTs are created by a service provider of NFT and put on the NFT marketplace 110. In one embodiment, the NFTs can be created by the users attending the venue. The users can sell the NFT already present with the user on the NFT marketplace 110.

The NFTs when purchased by the users are stored in a non-custodial wallet(s) 108 present on the application running on the end user device(s) 104 available with the users. The non-custodial wallet(s) 108 are a collection of NFTs that are owned by a specific user. The non-custodial wallet(s) 108 can be an array of references to addresses that represent each NFTs on the blockchain. The relationship is reflexive: the wallet can track the NFTs owned by the user, while the NFTs can store the user's address and authorize a set of activities for that user to do, including transferring or redeeming the ticket.

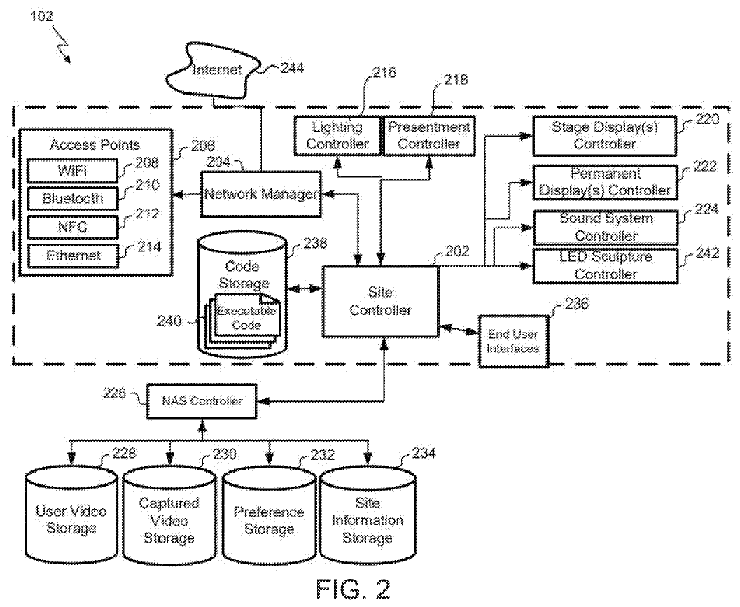

Referring to FIG. 2, now, a block diagram of the venue management device(2) 102 is shown, according to some embodiments of the present disclosure. Embodiments of a site controller 202 use a network manager 204 to connect via access points 206 (using e.g., a WiFi 208, a Bluetooth 210, a Near Field Technology (NFC) 212, an Ethernet 214, and/or other network connections) to other network components, such as site network and end user device(s) 104. In some embodiments, the site controller 202 controls aspects of an event location. A broad variety of location features can be controlled by different embodiments, including permanent lights (e.g., with a lighting controller 216), stage lights (e.g., with presentment controller 218), stage display screens (e.g., with stage display(s) controller 220), permanent display screens (e.g., with permanent display(s) controller 222), the location sound system (e.g., with the sound system controller 224) and LED sculpture controller 242.

A NAS controller 226 is coupled to a user video storage 228, a captured video storage 230, a preference storage 232, and a site information storage 234. The captured video storage 230 can receive, store and provide user videos received from end user device(s) 104. In some embodiments, the site controller 202 triggers the automatic capture of images, audio, and video from the end user device(s) 104, such triggering being synchronized to activities in an event. Images captured by this, and similar embodiments can be stored on both the capturing end user device(s) 104 and the user video storage 228. In an embodiment, the site controller 202 can coordinate the transfer of information from the end user device(s) 104 to the NAS controller 226 (e.g., captured media) with activities taking place during the event. When interacting with the end user device(s) 104, some embodiments of the site controller 202 can provide the end-user interfaces 236 to enable different types of interaction. For example, as a part of engagement activities, the site controller 202 can offer quizzes and other content to the devices. Additionally, for location determinations discussed herein, the site controller 202 can supplement determined estimates with voluntarily provided information using the end-user interfaces 236, stored in a storage that is not shown. The venue management device(s) 102 can be connected to an internet 244.

In some embodiments, to guide the performance of different activities, the site controller 202 and/or other components can use executable code tangibly stored in code storage 238 comprising executable code 240. In some embodiments, the site information storage 234 can provide information regarding the site, e.g., events, resource maps, attendee information, geographic location of destinations (e.g., concessions, bathrooms, exits, etc.), as well as 3D models of site features and structure.

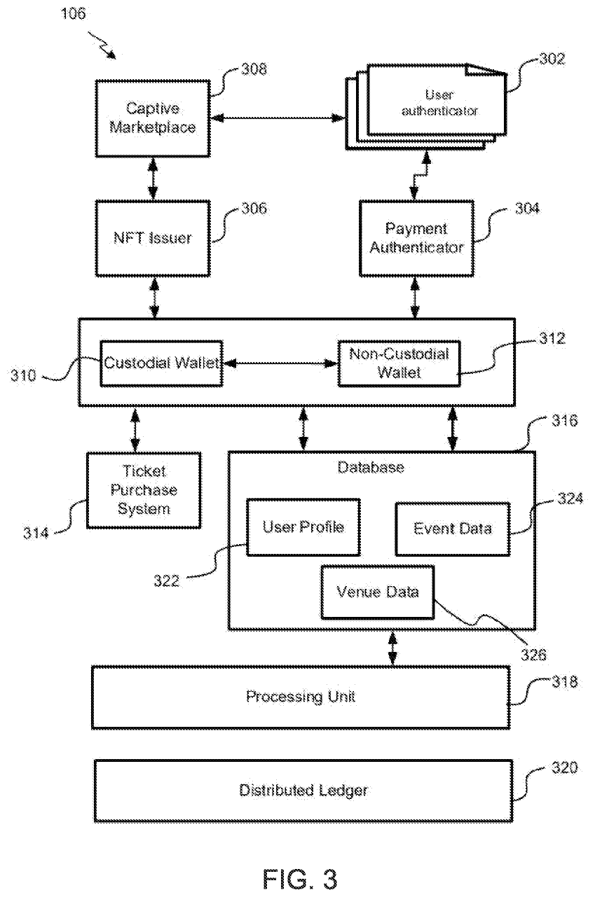

Referring to FIG. 3 now, a block diagram of server(s) 106 is shown according to some embodiment of the present disclosure. The server(s) 106 comprises a user authenticator 302, a payment authenticator 304, an NFT issuer 306, a captive marketplace 308, a custodial wallet 310 a non-custodial wallet 312, a ticket purchase system 314, a database 316, a processing unit 318, and a distributed ledger 320. Server(s) 106 is in communication with the end user device(s) 104 via the data communication network(s) 112.

Each time the user sends a request to purchase a ticket from the end user device(s) 104 available with the user, the ticket purchase request is received at the ticket purchase system 314 of server(s) 106. An example online purchase process can include a few or the following acts: providing the user over a network (e.g., the Internet) an event selection form, receiving the user event selection via the form; providing the user with a ticket request form; receiving the user ticket request criteria (e.g., number of tickets, price range, seat section, etc.); verifying that the user request complies with ticket purchase guidelines (e.g., does not exceed a specified maximum number of tickets); providing over the network a form used to better ensure that an automated program (e.g., a software robot) is not being used to purchase the ticket (e.g., by presenting a word that the user needs to type into a field); verifying that the user correctly completed the form; determining what are the available seats that meet the user's criteria; providing, over the network, the user with a listing of the seats being temporarily reserved for the user pending the user's purchase; providing over the network a ticket delivery instruction form; receiving or the network user ticket delivery instructions; receiving user registration information (e.g., name, contact information (such as street addresses, city, state, zip code, email address, phone number, instant messaging identifier, etc.) desired password, etc.) or account log in information (e.g., a password and/or a user identifier); verifying whether the user registration information is valid by user authenticator 302 present in the server(s) 106; receiving over the network payment information (e.g., credit card number and expiration date); verifying the payment information by payment authenticator 304, processing the issuance of the ordered tickets; and send a purchase confirmation to the user (e.g., via a Web page, an email, and/or an SMS message). In addition, the ticket purchase system 314 has to determine when a user has abandoned a purchase process (e.g., by determining if the user failed to complete a purchase process step within a designated time), and then has to release tickets reserved for that user so that other users can purchase the tickets. In one embodiment, the user authenticator 302 can be present on the end-user device 102 and the user authentication can be done using a biometric sensor present on the venue management device(s) 102.

The database 316 present in server(s) 106 can store user profile 322, event data 324, and venue data 326. The event data 324 can include the data related to the event, for example, but not limited to, names of performers/artists in the event, type of event, location of the event, ticket booking details of the event, etc. The venue data 326 can include venue related data, for example, but not limited to, location of the venue, number of seats available, type of seats available, the price range of each seat/ticket, number, and type of vendors present inside the venue, etc.

The user profile 322 can include the past and present behavior of the user. The behavior data can include events attended by the user historically, type of tickets bought by the user historically, a list of NFTs available with the user, a location of the user, favorite artists of the user, favorite venue of the user, other likes/dislikes of the user. The behavior data of the user can be tracked as soon as the user purchases the ticket for the venue. Upon purchasing the ticket by the user, an NFT is also assigned to the user by the NFT issuer 306. The NFT tracks the ownership of the user and ensures that the user who buys the ticket is the one who enters the venue. With the NFT, the user can be tracked if the user tries to sell the ticket, and enter the venue using the ticket. NFTs can also be linked with the type of ticket and venue of the event such that user behavior can be monitored.

Server(s) 106 can have two types of wallets namely custodial wallet 310 and non-custodial wallet 312. The custodial wallet 310 are the one that primarily stores the NFTs assigned to the user by the NFT issuer 306. The NFT issuer 306 can access the custodial wallet 310 and make changes to the custodial wallet 310. On the other hand, the non-custodial wallets 312 are the ones that are personal digital wallets of the user. The user can transfer the NFTs issued to them from the custodial wallet 310 to the non-custodial wallet 312. The NFT issuer 306 does not have any access to the non-custodial wallet 312 of the user. The user can transact/trade NFTs from the non-custodial wallets 312 present with the user. In one embodiment, the custodial wallet 310 and the non-custodial wallet 312 can be stored on the end-user device 102.

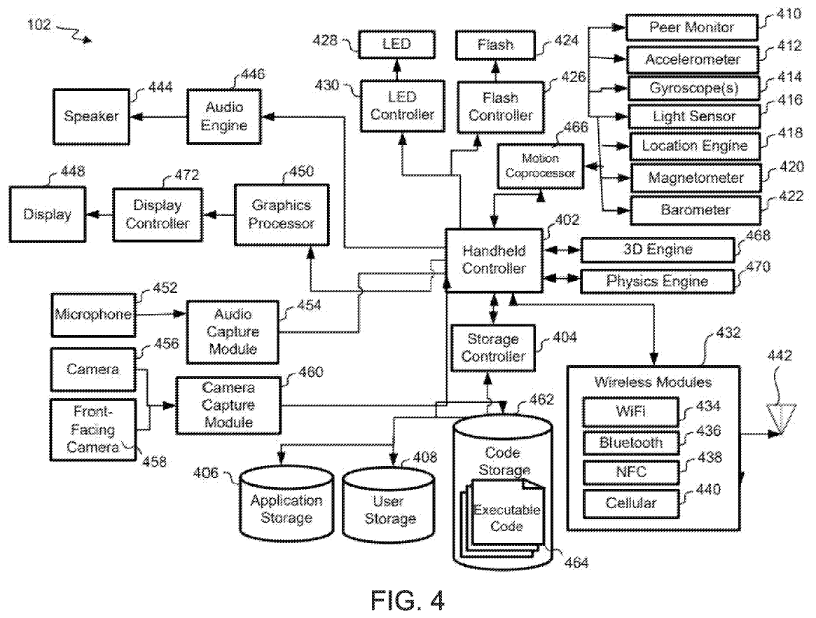

Referring to FIG. 4, a block diagram of the end-user device 102 is shown according to some embodiment of the present disclosure. The end-user device 102 includes a handheld controller 402 that can be sized and shaped so as enable the controller and end-user device 102 in a hand. The handheld controller 402 can include one or more end user-device processors that can be configured to perform actions as described herein. In some instances, such actions can include retrieving and implementing a rule, retrieving an access-enabling code, generating a communication (e.g., including an access-enabling code) to be transmitted to another device (e.g., a nearby client-associated device, a remote device, a central server, a server, etc.), processing a received communication (e.g., to perform an action in accordance with instruction in the communication, to generate a presentation based on data in the communication, or to generate a response communication that includes data requested in the received communication) and so on. In one embodiment, to guide the performance of different activities, the end-user device can use executable code tangibly stored in code storage 462 comprising executable code 464.

The handheld controller 402 can communicate with a storage controller 404 to facilitate local storage and/or retrieval of data. It will be appreciated if the handheld controller 402 can further facilitate storage and/or retrieval of data at a remote source via generation of communications including the data (e.g., with a storage instruction) and/or requesting particular data.

The storage controller 404 can be configured to write and/or read data from one or more data stores, such as application storage 406 and/or user storage 408. One or more data stores can include, for example, random access memory (RAM), dynamic random access memory (DRAM), read-only memory (ROM), flash-ROM, cache, storage chip, and/or removable memory. Application storage 406 can include various types of application data for each of one or more applications loaded (e.g., downloaded or pre-installed) onto end-user device 102. For example, one or more applications can include applications entailed for scanning the ticket at the entrance of the venue, the application running non-custodial wallets, and applications for other venue related purchases. Further, application data can include, for example, application code, settings, profile data, databases, session data, history, cookies, and/or cache data. User storage 408 can include, for example, files, documents, images, videos, voice recordings, and/or audio. It will be appreciated that end-user device 102 can also include other types of storage and/or stored data, such as code, files, and data for an operating system configured for execution on end-user device 102.

The handheld controller 402 can also receive and process (e.g., in accordance with code or instructions generated in correspondence to a particular application) data from one or more sensors and/or detection engines. One or more sensors and/or detection engines can be configured to, for example, detect the presence, intensity, and/or the identity of (for example) another device (e.g., a nearby device or device-detectable over a particular type of networks, such as a Bluetooth, Bluetooth Low-Energy or Near-Field Communication network); an environmental, external stimulus (e.g., temperature, water, light, motion or humidity); an internal stimulus (e.g., temperature); a device performance (e.g., processor or memory usage); and/or a network connection (e.g., to indicate whether a particular type of connection is available, network strength and/or network reliability). The sensors and detection engines include a peer monitor 410, an accelerometer 412, a gyroscope 414, a light sensor 416, a location engine 418, a magnetometer 420, and a barometer 422. Each sensor and/or detection engine can be configured to collect a measurement or make a determination, for example, at routine intervals or times and/or upon receiving a corresponding request (e.g., from a processor executing an application code).

The peer monitor 410 can monitor communications, networks, radio signals, short-range signals, etc., which can be received by a receiver of an end-user device 102. The peer monitor 410 can, for example, detect short-range communication from another device and/or use a network multicast or broadcast to request identification of nearby devices. Upon or while detecting another device, the peer monitor 410 can determine an identifier, device type, associated user, network capabilities, operating system, and/or authorization associated with the device. The peer monitor 410 can maintain and update a data structure to store a location, identifier, and/or characteristic of each of one or more nearby end-user devices 102.

The accelerometer 412 can be configured to detect the proper acceleration of end-user device 102. The acceleration can include multiple components associated with various axes and/or a total acceleration. The gyroscope 414 can be configured to detect one or more orientations (e.g., via detection of angular velocity) of end-user device 102. The gyroscope 414 can include, for example, one or more spinning wheels or discs, single- or multi-axis (e.g., three-axis) MEMS-based gyroscopes.

The light sensor 416 can include, for example, a photosensor, such as a photodiode, active-pixel sensor, LED, photoresistor, or other component configured to detect a presence, intensity, and/or type of light. In some instances, one or more sensors and detection engines can include a motion detector, which can be configured to detect motion. Such motion detection can include processing data from one or more light sensors (e.g., performing a temporal and/or differential analysis).

The location engine 418 can be configured to detect (e.g., estimate) the location of end-user device 102. For example, the location engine 418 can be configured to process signals (e.g., a wireless signal, GPS satellite signal, cell-tower signal, iBeacon, or base-station signal) received at one or more receivers (e.g., a wireless-signal receiver and/or GPS receiver) from a source (e.g., a GPS satellite, cellular tower or base station, or WiFi access point) at a defined or identifiable location. In some instances, the location engine 418 can process signals from multiple sources and can estimate the location of end-user device 102 using a triangulation technique. In some instances, the location engine 418 can process a single signal and estimate its location as being the same as a location of the source of the signal.

The end-user device 102 can include a flash 424 and a flash controller 426. The flash 424 can include a light source, such as (for example), an LED, electronic flash, or high-speed flash. The flash controller 426 can be configured to control when flash 424 emits light. In some instances, the determination includes identifying an ambient light level (e.g., via data received from the light sensor 416) and determining that the flash 424 is to emit light in response to a picture- or movie-initiating input when the light level is below a defined threshold (e.g., when a setting is in an auto-flash mode). In some additional or alternative instances, the determination includes determining that the flash controller 426 is, or is not, to emit light in accordance with a flash on/offsetting. When it is determined that the flash controller 426 is to emit light, the flash controller 426 can be configured to control the timing of the light to coincide, for example, with a time (or right before) at which a picture or video is taken.

The end-user device 102 can also include an LED 428 and an LED controller 430. The LED controller 430 can be configured to control when the LED 428 emits light. The light emission can be indicative of an event, such as whether a message has been received, a request has been processed, an initial access time has passed, etc.

The flash controller 426 can control whether the flash controller 426 emits light by controlling a circuit to complete a circuit between a power source and the flash controller 426 when the flash 424 is to emit light. In some instances, the flash controller 426 is wired to a shutter mechanism to synchronize light emission and collection of image or video data.

The end-user device 102 can be configured to transmit and/or receive signals from other devices or systems (e.g., over one or more networks, such as network(s)). These signals can include wireless signals, and accordingly, the end-user device 102 can include one or more wireless modules 432 configured to appropriately facilitate transmission or receipt of wireless signals of a particular type. The wireless modules 432 can include a Wi-Fi module 434, a Bluetooth module 436, a near-field communication (NFC) module shown as NFC 438, and/or a cellular module 440. Each module can, for example, generate a signal (e.g., which can include transforming a signal generated by another component of the end-user device 102 to conform to a particular protocol and/or to process a signal (e.g., which can include transforming a signal received from another device to conform with a protocol used by another component of end-user device 102).

The Wi-Fi module 434 can be configured to generate and/or process radio signals with a frequency between 2.4 gigahertz and 5 gigahertz. The Wi-Fi module 434 can include a wireless network interface card that includes circuitry to facilitate communicating using a particular standard (e.g., physical and/or link-layer standard). The Bluetooth module 436 can be configured to generate and/or process radio signals with a frequency between 2.4 gigahertz and 2.485 gigahertz. In some instances, the Bluetooth module 436 can be configured to generate and/or process Bluetooth low-energy (BLE or BTLE) signals with a frequency between 2.4 gigahertz and 2.485 gigahertz. The NFC 438 can be configured to generate and/or process radio signals with a frequency of 13.56 megahertz. The NFC 438 can include an inductor and/or can interact with one or more loop antennas. The cellular module 440 can be configured to generate and/or process cellular signals at ultra-high frequencies (e.g., between 698 and 2690 megahertz). For example, the cellular module 440 can be configured to generate uplink signals and/or to process received downlink signals.

The signals generated by the wireless modules 432 can be transmitted to one or more other devices (or broadcast) by one or more antennas 442. The signals processed by the wireless modules 432 can include those received by one or more antennas 442. One or more antennas 442 can include, for example, a monopole antenna, helical antenna, antenna, Planar Inverted-F Antenna (PIFA), modified PIFA, and/or one or more loop antennae.

The end-user device 102 can include various input and output components. An output component can be configured to present output. For example, a speaker 444 can be configured to present an audio output by converting an electrical signal into an audio signal. An audio engine 446 can affect particular audio characteristics, such as volume, event-to-audio-signal mapping, and/or whether an audio signal is to be avoided due to a silencing mode (e.g., a vibrate or do-not-disturb mode set at the device).

Further, a display 448 is provided with a display controller 472 and can be configured to present a visual output by converting an electrical signal into a light signal. The display 448 can include multiple pixels, each of which can be individually controllable, such that the intensity and/or color of each pixel can be independently controlled. The display 448 can include, for example, an LED- or LCD-based display.

A graphics processor 450 can determine a mapping of electronic image data to pixel variables on a screen of the end-user device 102. It can further adjust lighting, texture, and color characteristics in accordance with, for example, user settings.

In some instances, display 448 is a touchscreen display (e.g., a resistive or capacitive touchscreen) and is thus both an input and an output component. A graphics processor 450 can be configured to detect whether, where and/or how (e.g., a force of) a user touched display 448. The determination can be made based on an analysis of capacitive or resistive data.

An input component can be configured to receive input from a user that can be translated into data. For example, end-user device 102 can include a microphone 452 that can capture audio data and transform the audio signals into electrical signals. An audio capture module 454 can determine, for example, when an audio signal is to be collected and/or any filter, equalization, noise gate, compression, and/or clipper that is to be applied to the signal.

The end-user device 102 can further include one or more cameras 456, 458, each of which can be configured to capture visual data (e.g., at a given time or across an extended period) and convert the visual data into electrical data (e.g., electronic image or video data). In some instances, end-user device 102 includes multiple cameras, at least two of which are directed in different and/or substantially opposite directions. For example, end-user device 102 can include a rear-facing camera 456 and a front-facing camera 458.

A camera capture module 460 can control, for example, when a visual stimulus is to be collected (e.g., by controlling a shutter), a duration for which a visual stimulus is to be collected (e.g., a time that a shutter is to remain open for a picture taking, which can depend on a setting or ambient light levels; and/or a time that a shutter is to remain open for a video taking, which can depend on inputs), a zoom, a focus setting, and so on. When end-user device 102 includes multiple cameras, camera capture module 460 can further determine which camera(s) is to collect image data (e.g., based on a setting). In some embodiments, components are included that assist with the processing and utilization of sensor data. Motion coprocessor 466, 3D engine 468, and physics engine 470 can all process sensor data, and also perform tasks of graphics rendering related to graphics processor 450.

The end-user device 102 further includes a non-custodial wallet as explained above. The non-custodial wallet can store a list of NFTs owned by the user. As will be explained in detail below, the NFTs can be used to authenticate a user when the user is entering the venue, making a purchase inside the venue, providing incentives to users to attend an event, etc.

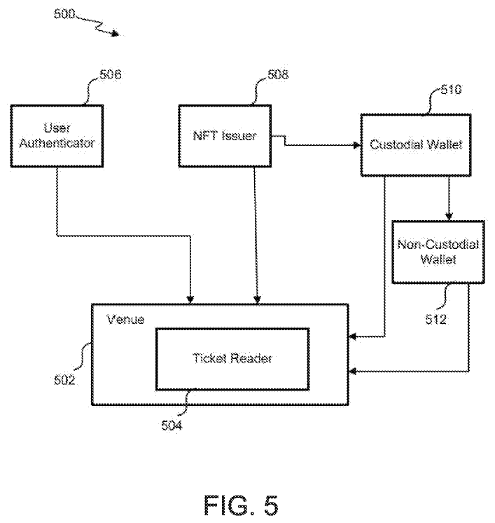

Referring to FIG. 5, now, a process flow 500 is illustrated in accordance with some embodiment of the present disclosure. When a user enters venue 502, a ticket reader 504 present at the entrance of the venue scans the ticket available to the user. The ticket can be present on an application running on the end-user device available with the user. The ticket reader 504 sends the details scanned from the ticket to a user authenticator 506. The user authenticator 506 verifies whether the user who bought the ticket and the user who is entering venue 502 are the same. Along with user authentication, the user authenticator 506 also makes use of the NFT issued to the user at the time of purchase of the ticket. Since the NFT is used to identify a true owner, it is easy to track the genuine owner of the ticket.

Once it is determined that the user who bought the ticket and the one who is trying to enter venue 502 are the same, an NFT issuer 508 assigns another NFT to the user as a token of incentive. The assigned NFT is primarily assigned in the custodial wallet 510 and then transferred to the non-custodial wallet 512 by the user. Finally, the NFT is stored in the non-custodial wallet 512 available to the user. More NFTs are awarded to the user as the user interacts more inside venue 502. For example, the NFTs can be awarded to the user for making an in-venue purchase. The NFTs can also be traded between users. The user having the highest number of NFTs can be rewarded. Since each NFT has a value associated with it, the user is motivated to attend more and more events and collect more and more NFTs.

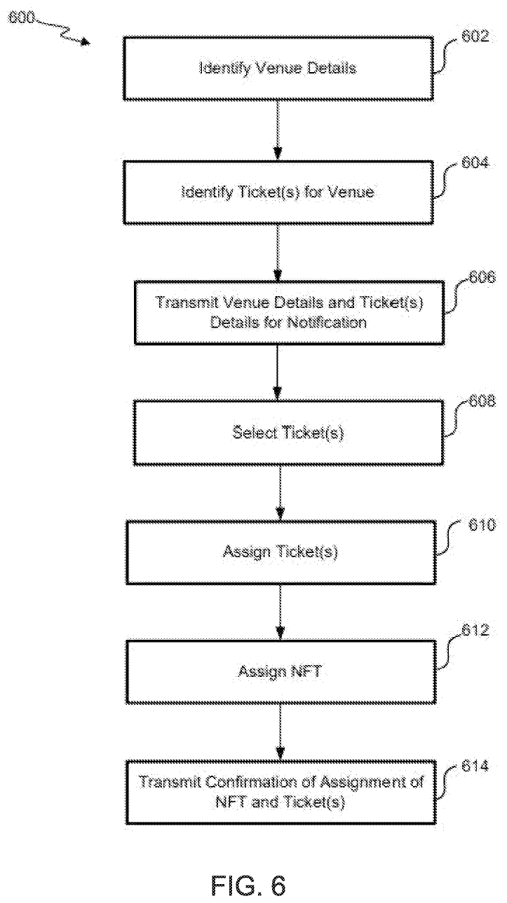

Referring to FIG. 6, now, a flowchart of process 600 for allocating a ticket to a user is described in accordance with some embodiment of the present disclosure. At block 602, venue details are identified on the server. The venue details can include a time at which the venue is to be available, a location of the venue, the capacity of the venue, and/or one or more entities (e.g., performing entities) associated with the venue. At block 604, tickets are identified for the venue. In some instances, the tickets to be allocated can correspond to different resource (e.g., seat) assignments.

At block 606, venue details and ticket details can be transmitted to, for example, one or more end-user devices and/or intermediate systems. The notification can include, for example, a network location (e.g., network location) that identifies a venue (via, at least in part, its specifications). The notification can include an option to request the assignment of one or more tickets. At block 608, the user of the end-user device selects the desired ticket(s) and sends the request to the server for the allocation of the ticket(s). At block 610, if the desired ticket(s) are available, the user is assigned the desired ticket or else an error message is transmitted to the user asking the user to re-select the ticket. If the tickets are allocated to the user, the status of the seats corresponding to the ticket(s) is marked as sold/unavailable.

Along with the ticket, an NFT is also assigned to the user, at block 612. The NFT can be randomly selected by the NFT issuer and can be transmitted to the user via the custodial wallet. In one embodiment, the NFT can be selected based on the value of the ticket purchases by the user. For example, a user who has purchased tickets of greater value can be assigned NFTs of greater value. The user can then transfer the NFT from the custodial wallet to the non-custodial wallet where the user has the access to the NFT. The issued NFT can be used to verify whether the user who has bought the ticket and the user who is entering the venue is the same. Once the ticket and the NFT are assigned to the user, a notification can be transmitted to the user, at block 614, confirming the assignment of the ticket and the NFT.

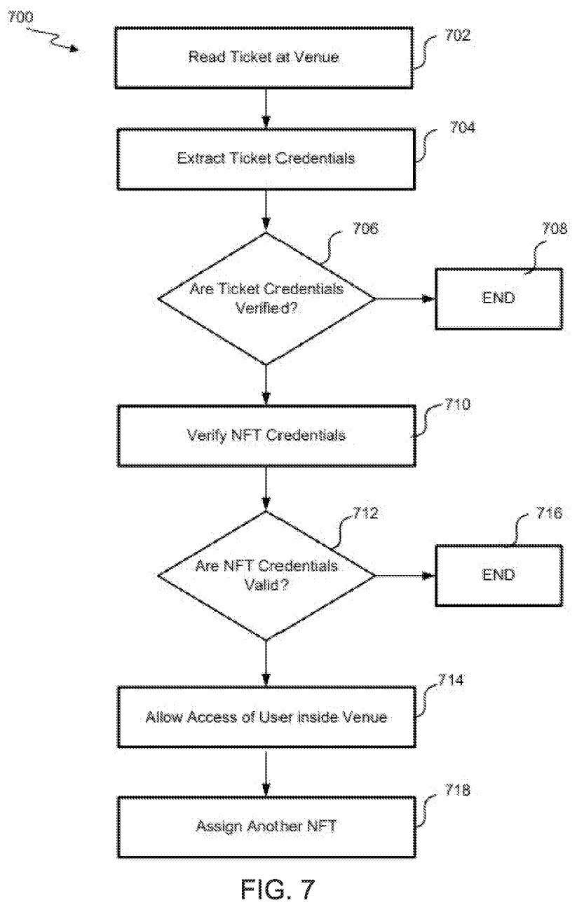

Referring to FIG. 7, now, a flowchart describing process 700 for entering a user inside the venue is illustrated, in accordance with some embodiment of the present disclosure. Process 700 begins when a user arrives at an entry of the venue. At block 702, tickets bought by the user are scanned at the venue by a ticket reader present at the entrance of the venue. At block 704, the ticket credentials are extracted. The ticket can have a bar code that can store necessary details relating to the authentication of the user at the venue. At block 706, the ticket credentials are verified. In one embodiment, to authenticate the user, the ticket credentials can be sent over the server(s) 106? which can the details relating to the ticket and the user to verify whether the user who bought the ticket is trying to enter the venue. In one embodiment, the ticket credentials are not sent to the server and the authentication of the user can be done using one or more biometric sensors present on the end-user device 102 or any computing device present at the venue. However, if the user credentials are not found to be valid, the user is not permitted access inside the venue and the process ends (block 708).

If the ticket credentials are found to be valid, at block 710, the NFT credentials are verified. The NFT(s) are assigned to a user along with a purchase of the ticket. The NFT credentials help verify whether the user who bought the ticket and the one who is entering the venue is the same. Since each NFT is exclusive for a user, it is easy to identify ownership of the ticket by verifying the NFT credentials. At block 712, if the NFT credentials are found to be valid, the user is permitted access inside the venue, at block 714. However, if at block 712, the NFT credentials are not found to be valid, the user is denied access inside the venue, and process 700 ends (at block 716). Further, to encourage the user to attend more events and to provide an incentive to the user for attending the current event, another NFT is assigned to the user, at block 718. The user can use this newly assigned NFT inside the venue for improving the in-venue purchase.

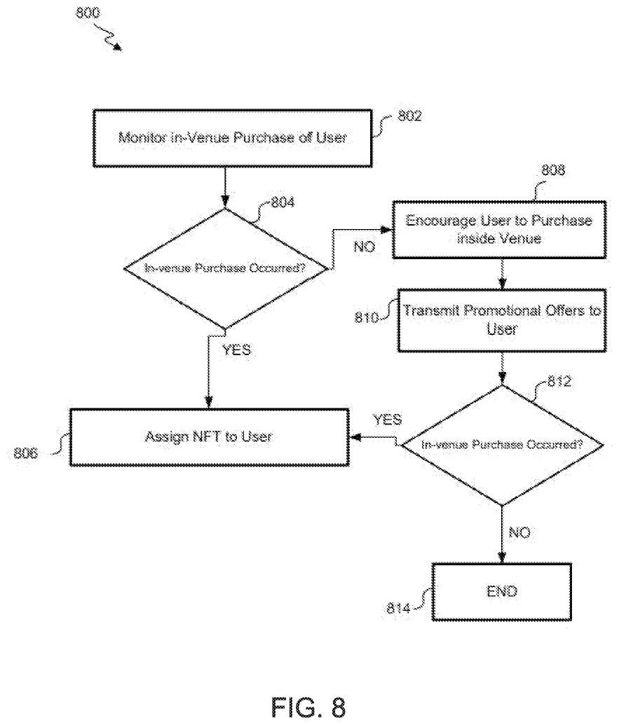

Referring to FIG. 8, now, a flowchart of process 800 for improving the in-venue experience of a user is illustrated, in accordance with some embodiment of the present disclosure. The venue management device(s) 102 encourages the user to purchase more so that more revenue can be generated for the venue. Since each NFT has a value associated with it, assigning NFTs on every purchase of the user can encourage the user to purchase more.

At block 802, in-venue purchases of the user are monitored. The in-venue purchases of the user indicate purchasing at the stores present inside the venue. The stores can be food stores, artist/team product franchise stores, other products (such as flags, T-shirts, boards, balloons) stores, etc. In one embodiment, monitoring the in-venue purchase of the user also indicates monitoring the location of the user to verify that the user is present inside the venue when making the purchase. At block 804, it is identified whether the user has made the in-venue purchase. If the in-venue purchase has occurred, an NFT is assigned to the user, at NFT block 806. The NFT is assigned to encourage more purchases inside the venue by the user.

However, at block 804, when it is determined that the in-venue purchase did not occur, the venue management device(s) 102 encourages the user to make more purchases inside the venue, at block 808. For this, at block, 810, the user is provided with promotional offers on their end-user devices. Promotional offers can be provided by the stores present inside the venue. In one embodiment, the offers are transmitted to the user in real-time. For example, the stores can transmit offers such as “buy anything within next 15 minutes and get an NFT”. Such offers would encourage the user to rush to the store to buy something so that they can be rewarded with NFT. In case the user makes an in-venue purchase, the process moves to block 812 where it is confirmed whether the in-venue purchase has occurred. If the in-venue purchase has occurred, the user is provided with NFT (block 806). In case the user still does not make the in-venue purchase, the process either ends at block 814 or the user is provided with more promotional offers.

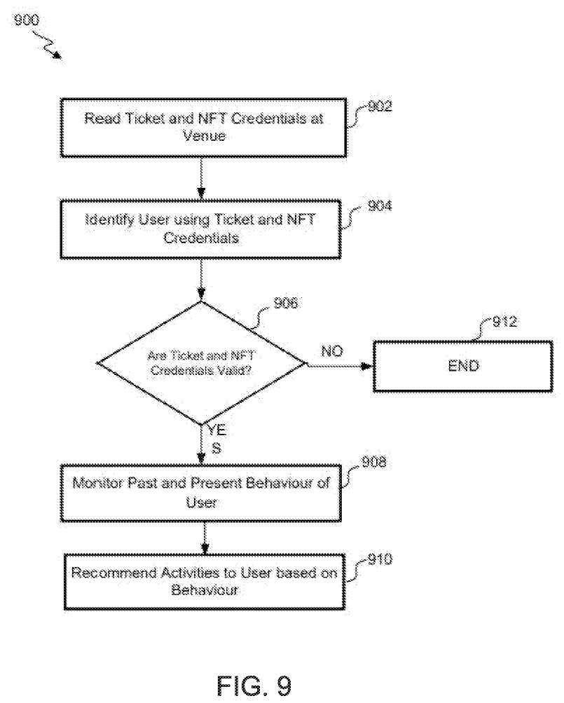

Referring to FIG. 9, now, a flowchart of process 900 for recommending activities to a user inside a venue is provided, in accordance with some embodiment of the present disclosure. At blocks 902 and 904, ticket credentials and NFT assigned to the user while purchasing the ticket are read and identified at the entrance of the venue. At block 906, if the ticket credentials and the NFT are found to be valid, process 900 moves to block 908 where the past and present behavior of the use is monitored. The behavior of the user can be monitored from the time NFT is assigned to the user. Based on the past and present behavior of the user, the user can be recommended with one or more activities, at block 910. The behavior of the user can include events attended by the user, the type of seats assigned to the user while attending the event, favorite performers/artists of the user, etc. Future events can include recommendations to the user regarding future events, and future venues based on the past and present behavior of the user. At block 906, if the ticket and NFT credentials are not valid, process 900 ends at block 912.

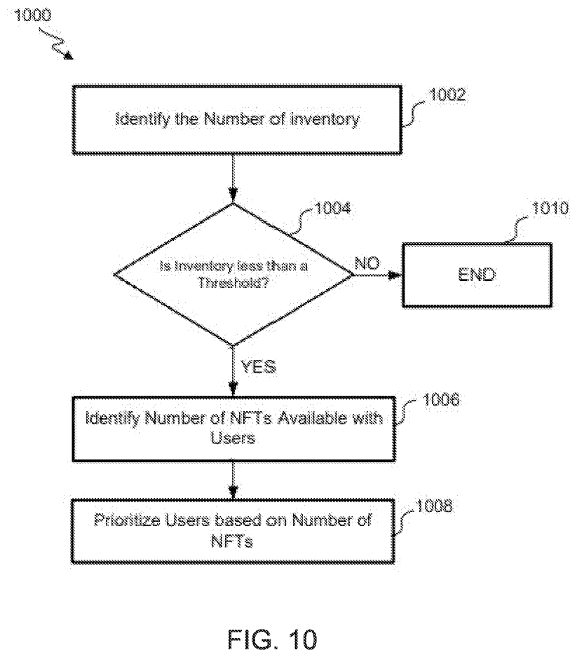

Referring to FIG. 10, a flowchart of a process for prioritizing users for purchasing tickets is provided in accordance with some embodiment of the present disclosure. At block 1002, the number of inventories is identified. The inventories can include the seats available in the venue. At block 1004, it is identified whether the number of inventories is less than a threshold value. If the inventories are fewer (i.e., tickets are fewer and users are more), several NFTs available with each user are identified, at block 1006. The users are prioritized based on the number of NFTs available with the user, i.e., the user who has more NFTs is given preference to the inventory as compared to the user having fewer NFTs, at block 1008. Thus, for example, the user having more NFTs can be given a better seat than the user having fewer NFTs. This encourages the user to collect more NFTs. If, however, the number of inventories is more than the threshold value, the process 1000 ends, at block 1010.

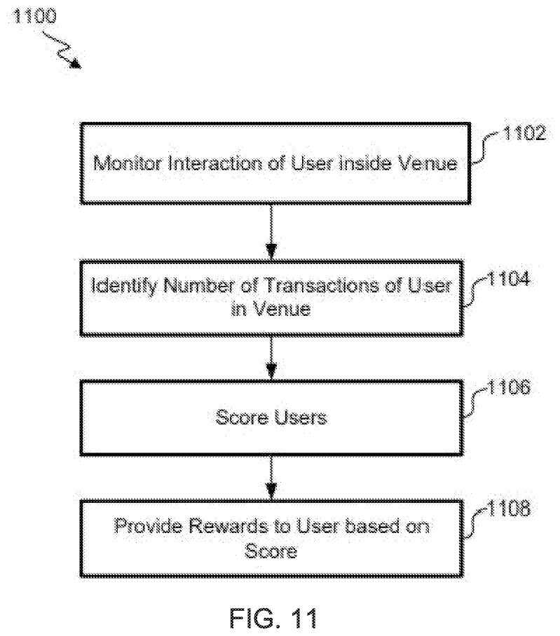

Referring to FIG. 11, a flowchart for process 1100 for providing rewards to users inside the venue is provided, in accordance with some embodiment of the present disclosure. At block 1102, interactions of the user inside the venue are monitored. The interactions can include, for example, but are not limited to, purchasing at a store inside the venue, interacting with kiosks present inside the venue, etc. At block 1104, the number of interactions of the user is identified. At block 1106, the users are scored based on the number of interactions inside the venue. For example, a user having more interactions can be scored better than a user having fewer interactions. At block 1108, rewards are provided to the user for interactions based on their scores. The scores can be in the form of NFTs. Thus, a user who interacts more (e.g., purchases more inside the venue) is given more NFTs than the user who interacts less. This encourages users to interact more.

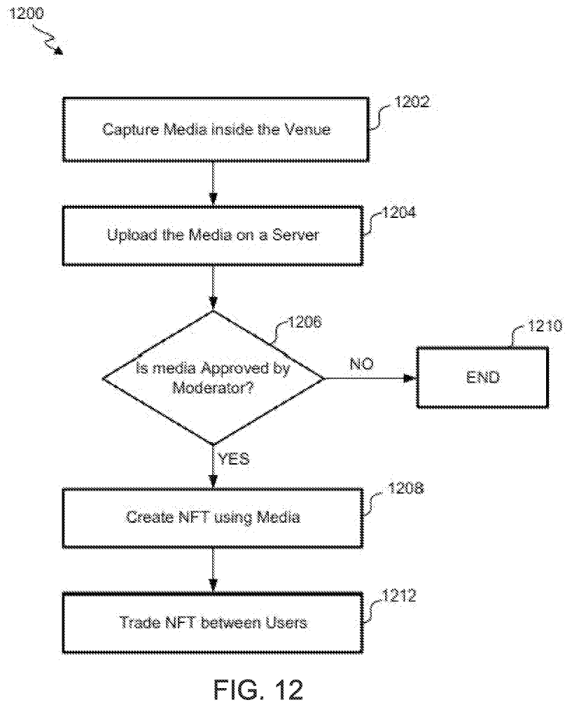

Referring to FIG. 12, now, a flowchart of process 1200 for creating NFT by users inside the venue is illustrated, in accordance with some embodiment of the present disclosure. At block 1202, media is captured by a user while attending an event at the venue. The media can include images, videos, etc. The media can be a rare video or an image that can not have been captured by cameras present at the venue. The user can then desire to make the media as NFT and can upload the captured media on server(s) 106 via an application running on the available with the user, at block 1204. After the media has been uploaded, a moderator verifies the media. The moderator can check if the media uploaded by the user is capable of becoming an NFT. At block 1206, it is verified whether the media has been verified by the moderator. If the media has been verified, the media becomes the NFT, at block 1208. However, if the media is not verified by the moderator, the process ends and the user is notified that the media cannot become NFT, at block 1210.

At block 1212, the users can trade using NFTs once the media has been approved by the moderator. The approved NFTs are placed on the NFT marketplace where the users can buy NFT and store it in their non-custodial wallet(s) 108. The users can trade these NFTs with other users. Also, the service provider can use these NFTs for incentivizing users and the user who captured the NFTs is awarded royalties in return. Thus, if the media captured by the user becomes NFTs, the user can earn while attending the event. This encourages the user to buy better seats (for example, to front-row seats) in the venue as it is easy to capture rare media from better seats.

In one embodiment, the service provider can provide an environment where the duration of the event can be increased by trading NFTs. For example, a fire-like visualization effect can be created by the venue management device(s) 102 where the service provider can ask the users to virtually thrown NFTs inside the fire. As users throw NFTs, the duration of the event keeps increasing based on the value of the NFTs. This encourages the user to collect more NFTs by interacting more inside the venue.

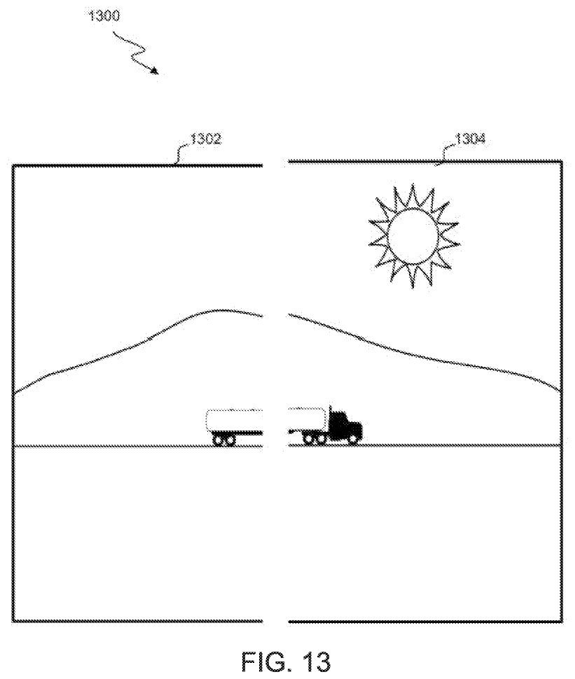

Referring to FIG. 13, now, an example embodiment of NFT 1300 is shown in accordance with some embodiment of the present disclosure. The NFT 1300 is divided into two parts—1302 and 1304. The NFT 1302 can be obtained when a user purchases the ticket and the NFT 1304 can be obtained when the same user is trying to enter the venue. When combining NFTs 1302 and 1304 makes a bigger picture (scenery), it can be confirmed that the same user who purchases the ticket is trying to enter the venue.

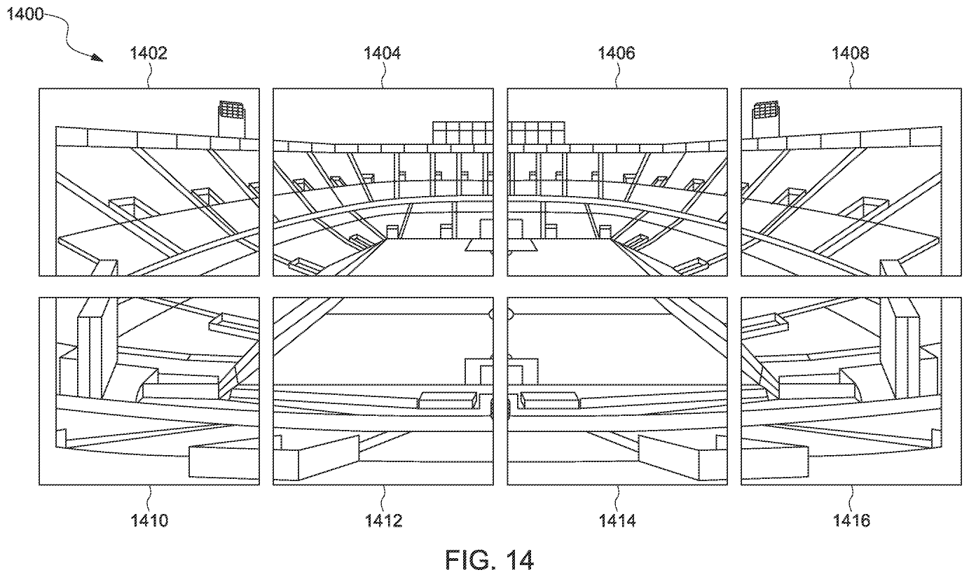

Referring to FIG. 14, now, an example embodiment of NFT 1400 collected by a user while interacting within the venue is shown in accordance with some embodiment of the present disclosure. The NFT 1400 is divided into 8 parts 1402-1416 which can be obtained while interacting inside the venue. For example, part 1402 can be obtained when the user purchases the ticket, part 1404 can be obtained when the user is trying to enter the venue, part 1406 can be obtained when the user makes a purchase of food inside the venue, part 1408 can be obtained when the user makes a purchase franchise inside the venue, etc. As the user interacts more inside the venue management device(s) 102, the user can obtain more parts 1402-1416. When parts 1402-1416 are obtained by the user, a bigger picture of NFT 1400 is obtained. Rewards can be provided to the user when the user obtains the bigger picture of NFT 1400 by combining the parts 1402-1416. This will encourage the user to interact more inside the venue and obtain parts 1402-1416.

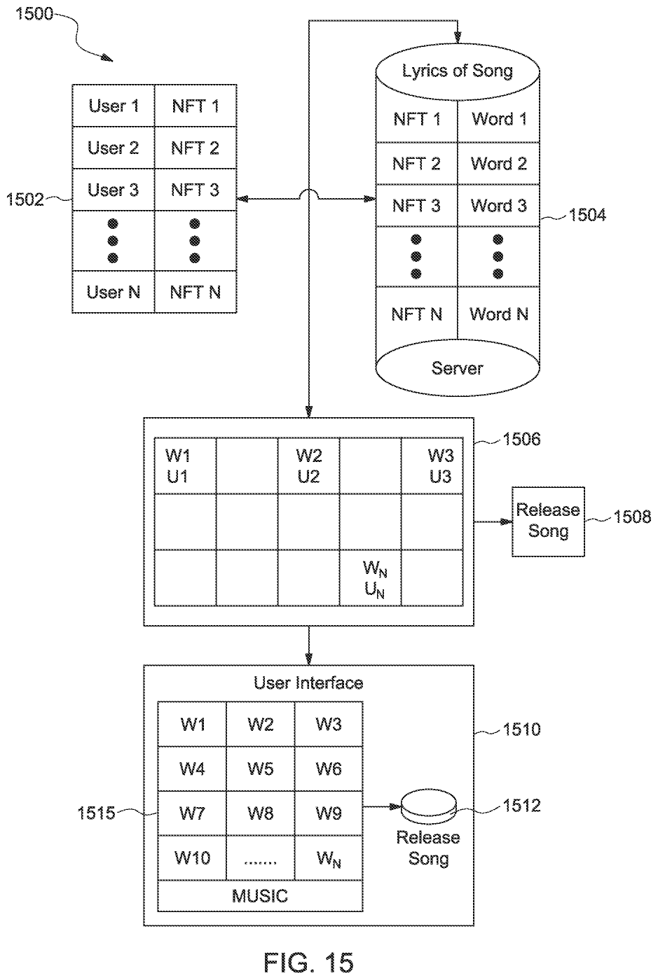

Referring to FIG. 15, now, an example embodiment of an NFT-based engagement of users according to another embodiment of the present disclosure. The NFT-based fan engagement system 1500 is a mechanism to identify genuine users and filter those genuine users from brokers or Robo users. Further, the NFT-based fan engagement system is configured to empower genuine fans to release a new album stored in the first database and earn rewards in terms of updated NFTs.

In some implementations, for releasing a new album or artwork, any artist renders a presale/album release notification to all the users registered in the whitelist of the first database or via social media or print media with the date and venue information so that maximum users can participate in the mega event. For attending the album release event, users go to system platform for purchasing tickets for the upcoming event.

In one exemplary embodiment, 1502 represents an assignment of NFTs to users. For example, user 1 is assigned with NFT 1, user 2 with NFT 2, and user N with NFT N. The lyrics of the album are already stored in the first database and not available to the public domain prior to public release. For every word of the song, the system mints a unique NFT. For example, at 1504, NFT 1 corresponds to word 1, NFT 2 corresponds to word 2, and so on. Each user is assigned a unique NFT while purchasing tickets for the album release event. The NFT includes digital assets associated with at least one artwork (album, lyrics of song, one word, or painting) related to the upcoming event. The system platform enables all the users with tickets and NFTs to collaborate with a certain set of rules in order to decode the lyrics of the song which results in getting rewards in terms of upgraded NFTs, unlocking the locked features related to access rights, and providing discounts on various purchases.

In some implementations, once all users submit the NFTs associated with the lyrics of the song, each user, in a collaborative fan-based community 1506, tries to mix and match the words to decode the actual song lyrics with a radio button 1508 (passive state) to release the song after decoding the lyrics. For each user, the final version of their lyrics is compared with the actual lyrics of the song stored in the database.

In one exemplary embodiment, the system platform compares the song lyrics generated by the user with the actual lyrics stored in the database. Based on the determination of progress in the decoding lyrics, the system generates various hints in the form of audio-visual messages to motivate the users to proceed further. The system platform provides a user interface 1510 in the form of an application for community-based activity. The user interface 1510 provides all the NFTs submitted by individual users and displayed as shuffled song lyrics 1515. Once the system determines that at least one user device decoded the song lyrics 1515, radio button 1512 turns into an active state from a passive state (release button) and background music associated with that song appears on the system platform. The system enables the user device to release that song and a new NFT is issued to the user's device.

In another embodiment, new users can raise a request, on the credential server, for becoming a member of the whitelist. Furthermore, the new users can either raise a purchase request or can adopt a referral system to be a part of the whitelist. Accordingly, new users can be added to the whitelist based on either payment confirmation or based on response from at least one existing member in terms of the referral system.

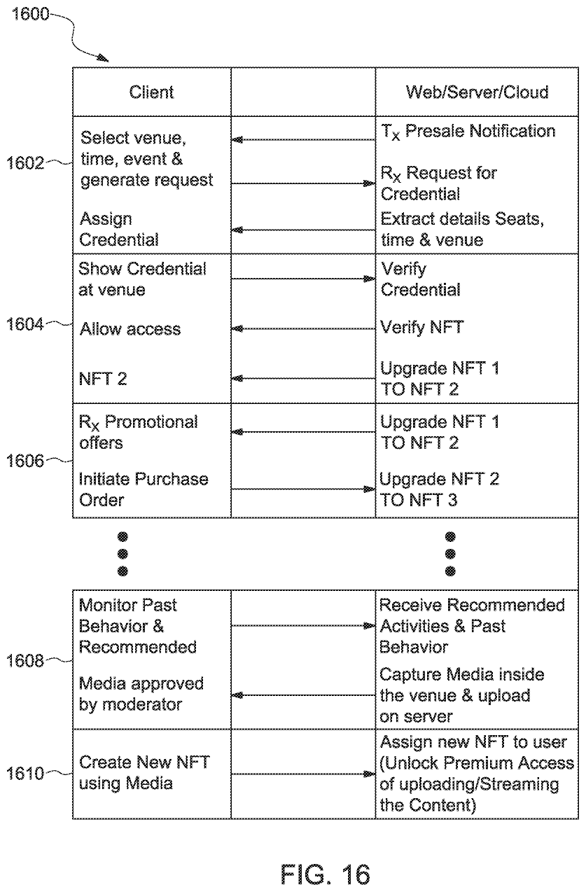

Referring to FIG. 16, now, an example embodiment of the process flow of assigning credentials linked with NFT according to another embodiment of the present disclosure. Process flow 1600 depicts the transmission of presale notifications and ticket requests and steps describing information exchange between the user device and the credential server.

In some implementations, step 1602 describes an interaction between the user device and server where a presale notification, associated with an event, is being transmitted by the server to the user device over a communication channel. Upon receiving the presale notification, the user device generates a request for access rights (e.g. tickets) for the event and provides information such as venue, time, and type of access rights needed, etc. The request is transmitted from the user's device to the server. At the server, a processor enquires about all available tickets and based on a request raised by the user extracts details of seats, venue, and time and assigns those tickets to the user along with a unique NFT. Finally, the server transmits a notification to the user device indicating confirmation of ticket booking by the user device. The payment for purchasing the tickets is raised along with raising the request by the user's device.

In one another embodiment, step 1604 describes ticket verification and validation at the venue for attending the event. For any event, at the entry gate, a scanning device scans the ticket and NFT (e.g. NFT1) associated with the ticket and compares it with the information stored in the database. Upon successful verification, the user associated with the user device is allowed to access the resources and occupied the allocated seats and an updated NFT (NFT2) is issued to an account associated with the user device.

In another exemplary embodiment, in case at least one credential (ticket or NFT) does not match the information in the database, the permission to access the resource is denied and NFT is withdrawn and issued back to the NFT issuer.

In one another embodiment, step 1606 describes subsequent actions triggered by the system upon determination of successful verification of the tickets and entry of the user in the venue. In another embodiment, step 1608 describes that the system is configured to generate a plurality of recommendations (e.g. offers, discounts) based on historical information associated with the user account or the user device and transmits the plurality of offers to the user device via a communication channel. In case the user device, in response to reception of such offers, initiates an action to avail benefits of at least one recommendation, a new NFT ‘123’ with the higher value is issued to the user account associated with the user device. The issued NFT ‘123’ will get upgraded each time the user device initiates a purchase order or triggers an action associated with the event.

In some implementations, step 1610 describes providing premium access to the user device to record the live event and stream on social media and earn more NFTs based on the traffic generated by the user device on social media.

In another exemplary embodiment, the user device is provided with access rights to access media captured and posted by other users which is available to only premium users.

In another exemplary embodiment, the NFT linked with the credentials is a digital asset that represents ownership or proof of attendance for a specific event or venue. The NFT is stored on the blockchain, which is a decentralized and distributed digital ledger that allows for secure and transparent record-keeping.

In some implementations, when the credentials are assigned for the time bound access, the user account associated with the user device is issued one NFT that is linked to the credentials. This NFT contains information about the event, such as the date, location, and number of credentials available with additional information such as the priority index of the user device based on NFT values. It also contains a unique identifier that is associated with specific credentials. The credentials comprise at least one admittance pass, entry permit, admission voucher, access token, fare token, reservation confirmation, entry pass, coupon, token, badge, slip, slip of paper, sticker, label, tag, or stub.

In another exemplary embodiment, when the credentials (access rights for accessing the resource) are presented at the event, it is validated by the resource (e.g. a venue for any event) to ensure that it is legitimate. If the credentials are valid, the NFT linked to the ticket is updated on the blockchain to reflect that the credentials have been used. This update can include information such as the time and location of the event, and the identity of the person who used the credentials.

In another exemplary embodiment, the use of NFTs and blockchain technology in ticketing provides several benefits over traditional paper or digital tickets. Firstly, it eliminates the possibility of counterfeit tickets, as each NFT is unique and cannot be replicated. Additionally, it allows for transparency and traceability, as all transactions and updates to the NFT are recorded on the blockchain and can be easily accessed and verified by anyone. Furthermore, another advantage is that NFTs can be resold or traded on secondary markets, as they are unique and have value in their own right, unlike traditional tickets which only have value when the event occurs.

In another exemplary embodiment, the NFT linked with a ticket is a digital asset that provides ownership and proof of attendance for an event. It is stored on a blockchain, which allows for secure and transparent record-keeping, and is updated upon successful validation of the ticket, providing a secure and transparent solution for ticketing.

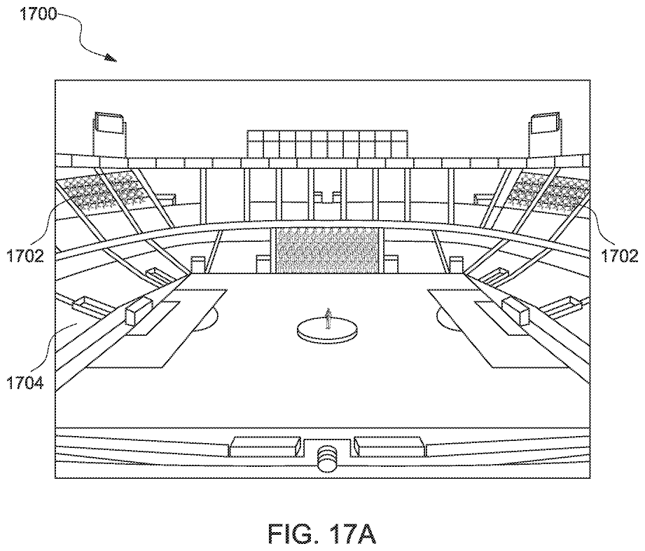

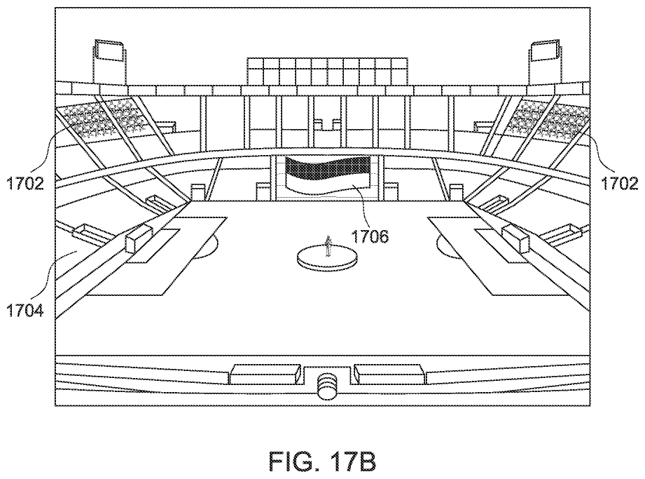

Referring to FIG. 17A, now, is an example embodiment of an event with the audience attending the event according to another embodiment of the present disclosure. Referring to FIG. 17A represents an exemplary representation of a live event at a venue of 17000 where an artist can perform in front of an audience 1702 (e.g. users who have purchased tickets). The seating arrangements of the audience are also pre-decided based on the ticket allocation and unique NFTs were also assigned to the user accounts associated with the user devices. Further, the system is configured to track any user based on its location and trigger recommendations based on the location of the user sitting in the stands 1704 of venue 1700.

Referring to FIG. 17B, is now, an example embodiment of creating giant artwork using NFTs according to another embodiment of the present disclosure. FIG. 17B represents the creation of an artwork by combining different NFTs issued to each user during ticket booking. For example, audience 1702 sitting in a particular group or all users in the venue, when instructed either by the artist or by pop-up notification on the user devices, display their NFTs simultaneously. This activity results in the creation of an artwork 1706 (e.g. a flag of a nation). Furthermore, the system is configured to assign updated NFTs to all the users who were involved in creating the giant artwork 1706.

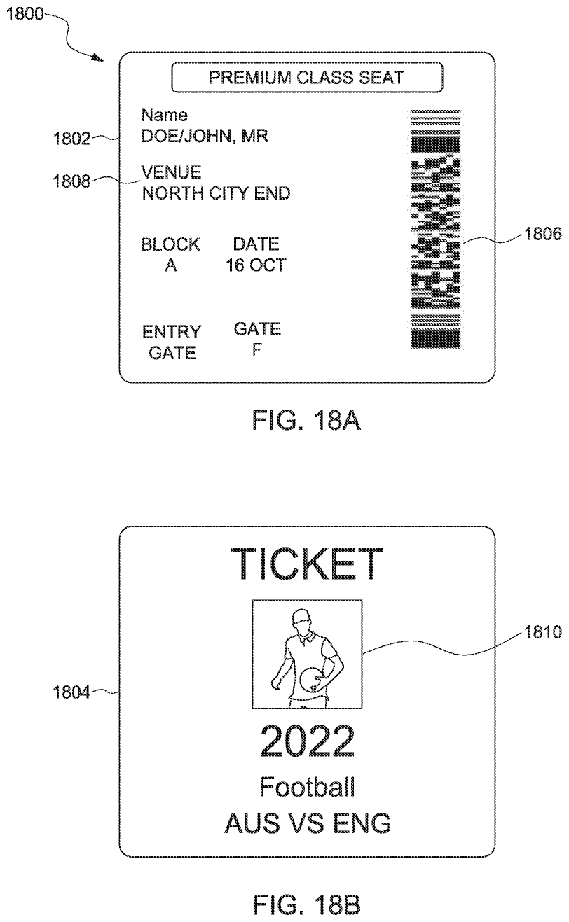

Referring to FIG. 18A is now, an example embodiment of the front side of credentials according to another embodiment of the present disclosure. FIG. 18A represents an exemplary embodiment of the ticket 1800. In yet another embodiment, FIG. 18A represents a front side of a ticket 1802 and FIG. 18B represents the rear side of ticket 1804. The front side of ticket 1802 typically includes, but is not limited to only, details of the user 1808 who booked the ticket, venue details 1808, and a barcode 1806 for scanning the ticket during entry into a venue. In addition, the rear side of ticket 1804 includes an exemplary representation of NFT 1810 along with various other details such as recommendations or additional details related to the event.

In yet another embodiment, during entry into a venue, each ticket is verified via the tokenization and securitization process. The verification includes obfuscation of the barcode code 1806 that is entailed for entry and verification of NFT 1810 associated with the ticket by comparing it over the blockchain. The barcode 1806 gets invalidated once scanned at the entry point to avoid false entries in the venue via fake tickets.

In yet another embodiment, after the completion of an event, the user can keep the NFTs in their non-custodial wallet for future reference (e.g. bookings, purchasing, etc.). In addition, the user can initiate a request, via the user device, to convert the owned NFTs into digitally visible coupons for usage at some other events.

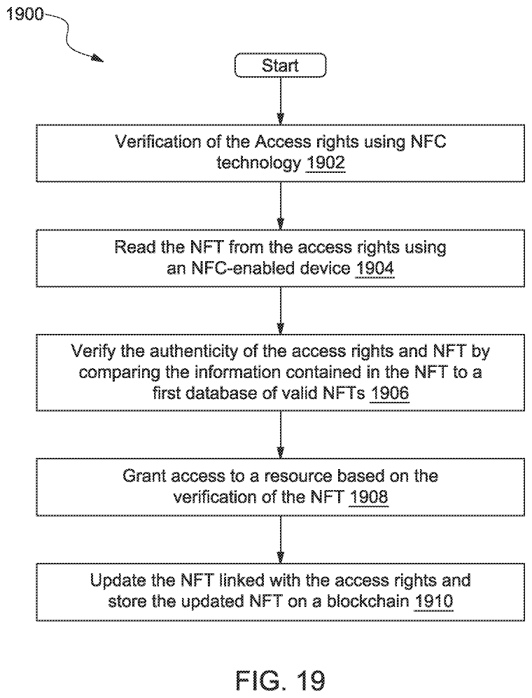

FIG. 19 illustrates an example flowchart of verification of the access rights using NFC technology. Referring to FIG. 19 demonstrates a flowchart of an example process 1900. In some implementations, one or more process blocks of FIG. 19 may be performed by a system or device.

As shown in FIG. 19, process 1900 may include assigning an NFT to the access rights based on assignment of the access rights to an account associated with a user device. Moreover, the NFT includes information identifying the access rights and personal identification information of the account associated with the user device (block 1902). For example, device may assign an NFT to the access rights based on assignment of the access rights to an account associated with an user device. Also, the NFT includes information identifying the access rights and personal identification information of the account associated with the user device, as described above. As also shown in FIG. 19, process 1900 may include reading the NFT from the access rights using an NFC-enabled device (block 104). For example, device may read the NFT from the access rights using an NFC-enabled device, as described above.

As further shown in FIG. 19, process 1900 may include verifying the authenticity of the NFT by comparing the information contained in the NFT to a first database of valid NFTs (block 1906). For example, device may verify the authenticity of the NFT by comparing the information contained in the NFT to a first database of valid NFTs, as described above. In addition, the process 1900 may include granting access to a resource based on the verification of the NFT (block 1908) and updating the NFT linked with the access rights. Furthermore, the updated NFT and access rights are stored on a blockchain (block 1910), as described above.

Although FIG. 19 shows example blocks of process 1900, in some implementations, process 1900 may include additional blocks, fewer blocks, different blocks, or differently arranged blocks than those depicted in FIG. 19. Additionally, or alternatively, two or more of the blocks of process 1900 may be performed in parallel.

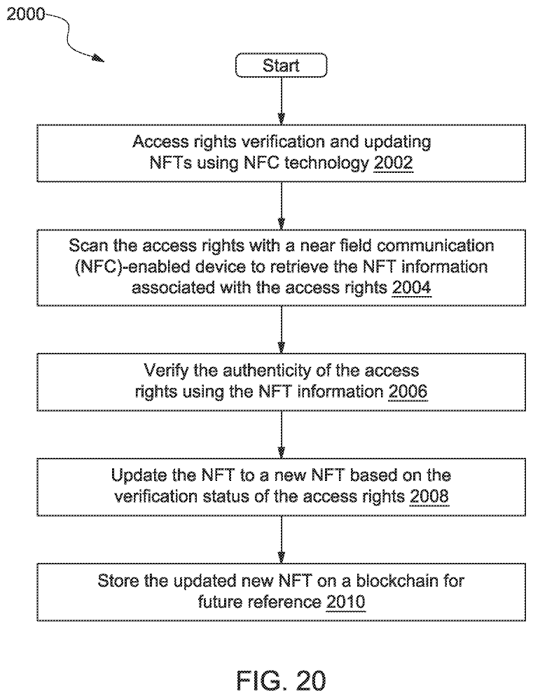

FIG. 20 illustrates an example flowchart of access rights verification and updating NFTs using NFC technology. Referring to FIG. 20 discloses a flowchart of an exemplary process flow 2000.

As shown in FIG. 20, process 2000 may include assigning an NFT to access rights to an account associated with a user device. Also, the NFT includes information identifying the access rights and personal identification information of the account associated with the user device (block 2002). In addition, the process 2000 may include scanning the access rights with an near field communication (NFC)-enabled device to retrieve the NFT information associated with the access rights (block 2004) and verifying the authenticity of the access rights using the NFT information (block 2006). For example, device may verify the authenticity of the access rights using the NFT information, as described above. As also shown in FIG. 20, process 2000 may include updating the NFT with the verification status of the access rights (block 2008) and storing the updated NFT on a blockchain for future reference (block 2010).

Although FIG. 20 shows example blocks of process 2000, in some implementations, process 2000 may include additional blocks, fewer blocks, different blocks, or differently arranged blocks than those depicted in FIG. 20. Additionally, or alternatively, two or more of the blocks of process 2000 may be performed in parallel.

In some implementations, the device may include assigning an NFT to the access rights based on assignment of the access rights to an account associated with a user device, where the NFT includes information identifying the access rights and personal identification information of the account associated with the user device. In addition, the device may include reading the NFT from the access rights using an NFC-enabled device. The device may include verifying the authenticity of the NFT by comparing the information contained in the NFT to a first database of valid NFTs. Moreover, the device may include granting access to a resource based on the verification of the NFT. Also, the device may include updating the NFT linked with the access rights and store the updated NFT on a blockchain.

In some implementations, the device may include assigning an NFT to access rights to an account associated with a user device, where the NFT includes information identifying the access rights and personal identification information of the account associated with the user device. In addition, the device may include scanning the access rights with an near field communication (NFC)-enabled device to retrieve the NFT information associated with the access rights. The device may include verifying the authenticity of the access rights using the NFT information. Moreover, the device may include updating the NFT with the verification status of the access rights. Also, the device may include storing the updated NFT on a blockchain for future reference.

In yet another embodiment, validating the access rights using NFC (near field communication) technology in conjunction with NFTs is a way to ensure the authenticity and uniqueness of the access rights, while also providing a convenient and secure way for the access rights holders to access the events.

In yet another embodiment, the NFC is a short-range wireless communication technology that enables the exchange of data between two devices, such as the user device (e.g. a smartphone) and an access rights management device (e.g. a ticket reader). Additionally, the exchange of data between the two devices is enabled when the two devices are brought within close proximity of each other. This technology is advantageous for contactless access rights verification and initiating additional transactions while accessing one or more resources.

In yet another embodiment, the NFTs are digital assets that are unique and cannot be replicated or exchanged for an equivalent item. Moreover, NFTs are typically used to represent items such as digital art, collectibles, and, in this case, tickets for an event.

In yet another embodiment, to validate the access rights and NFT using NFC technology, the access rights issuer would first create an NFT that represent the access rights or create an NFT along with the access rights. This NFT would be stored on a blockchain, which is a decentralized, digital ledger that allows for the secure and transparent recording of transactions.

In yet another embodiment, when the access rights holder is ready to use their access rights to access an event, they would open a corresponding mobile app in their user device (e.g. phone) and present their user device to an access rights reader. The access rights reader would then use NFC technology to communicate with the user device and retrieve the NFT and/or access rights from the blockchain. The NFT would then be checked against the event's database to ensure that the access rights are valid and has not been used before.

In yet another embodiment, verification of the access rights using NFC technology eliminates the need for physical access rights, which can be lost or stolen, and reduces the risk of ticket fraud. Additionally, it allows for real-time tracking of access right usage, which can be useful for resource organizers and access rights sellers.

In yet another embodiment, the validation of access rights and NFT using NFC technology is a secure way to ensure the authenticity and uniqueness of the access rights. Moreover, verification and providing access to the user device using NFC eliminates the need for physical access rights. Besides, it also provides a way for access rights holders to access events while also providing valuable data to the system, event organizers, and access rights sellers.

Also, the system is further configured to receive the information and/or data provided by the access rights holder while attending the event and based on the received data, the system generates various recommendations for the access rights holders in real-time using machine-learning techniques. The system generated recommendations are transmitted to the user device.

In yet another embodiment, NFTs provide a secure way to represent digital assets, such as concert tickets, game items, and collectibles. Additionally, to verify the authenticity of the NFTs and tickets associated with the NFTs, a contactless NFC technology provides multiple technical benefits.

In yet another embodiment, the authenticity of the access rights is verified using the NFT information and scanning the access rights with an NFC-enabled device to retrieve the NFT information associated with the access rights. Also, in case the access rights is determined to be authentic, the NFT is updated with the verification status of the access rights. The updated NFT is then stored on a blockchain for future reference.

In yet another embodiment, one of the main advantages of using NFC technology for access rights validation is its speed and convenience. Moreover, the NFC technology allows for scanning of the access rights without the need for additional equipment or infrastructure. This makes it useful for event venues and other locations where a large number of access rights need to be validated in a short period of time.

In yet another embodiment, another advantage of using NFC technology is its security features. The NFC-enabled devices have built-in security features that prevent unauthorized access and tampering. Accordingly, this ensures that the access rights and the associated NFT are secure and cannot be duplicated or forged.

In yet another embodiment, the NFC technology is well-suited for the use case of access rights validation and NFT management. Moreover, the NFC is a short-range wireless technology that enables communication between devices within a few centimetres. Accordingly, this approach makes it for use cases where the authenticity of an object needs to be verified in close proximity, such as when access rights is scanned at the entrance to an event venue.

In yet another embodiment, the NFC has the added advantage of being a low-power technology. This means that it can be used with battery-powered devices, such as smartphones and smartwatches, without significantly affecting the battery life.

In yet another embodiment, the use of NFC technology for the validation of access rights linked with NFTs and the generation of updated NFTs based on access rights verification provides a fast, convenient, and secure solution. In addition, the use of the NFC technology in this context offers several technical advantages, including speed, security, and low-power usage. The integration of NFC technology with blockchain technology ensures that the updated NFTs are stored securely and can be easily accessed for future reference.

In some implementations, one or more access rights (e.g., electronic tickets) and the NFT associated with the resource (e.g., an event) can be automatically assigned to the user device based on an initial request raised by the user device for accessing that resource after receiving the presale notification. Advantageously, automatically assigning access rights to the user devices can reduce the probability of allocation of access rights to robot users or brokers and genuine. In other words, genuine users were given priority and brokers or the Robo users were deprioritized from assigning access rights, thereby providing an efficient process for filtering the robot users or brokers from the genuine users and providing all the promotional and beneficial offers to the genuine users for ongoing and future events.

In one embodiment, the present disclosure provides one or more techniques for using Non-Fungible Tokens (NFTs) inside a venue. The NFTs are allocated to the user at the time of purchase of tickets, which can be used to authenticate the user while entering inside the venue. More NFTs are allocated to users as the users interact inside the venue. Since NFTs have a value associated with them, users can buy/sell/trade NFTs. Thus, users are encouraged to interact more inside the venue so as to collect more and more NFTs.

In another embodiment, the present disclosure provides techniques for purchasing tickets for a live event. The techniques comprise receiving a request for tickets from a user, extracting details, for example, but not limited to, seats from the ticket, wherein the details comprise a type of seats desired by the user, assigning the tickets to the user based on the type of seats desired by the user, assigning a non-fungible token to the user along with the ticket, and transmitting a confirmation of the ticket and the non-fungible token to the user.

In another embodiment, the present disclosure provides techniques for reading tickets at a venue. The techniques comprise scanning tickets at an entrance of the venue, verifying tickets and non-fungible tokens at the entrance of the venue, wherein the non-fungible tokens (NFTs) are assigned to the user along with the purchase of the tickets, permitting access to the user in the venue if the verification of the tickets and the non-fungible tokens are successful, and assigning another NFT to the user if the verification of the tickets and the non-fungible tokens are successful.

In another embodiment, the present disclosure provides techniques for monitoring interactions of a user inside a venue. The techniques comprise monitoring in-venue purchases of the user, wherein when the in-venue purchase occurs, assigning a non-fungible token to the user, and when the in-venue purchase does not occur, transmitting promotional offers to the user to encourage the user to make more purchases inside the venue.

In yet another embodiment, the present disclosure provides techniques for recommending activities to a user. The techniques comprise reading the ticket and NFT credentials the entrance of the venue, verifying the authenticity of the user based on the reading of the ticket and NFT credentials, and monitoring the past and present behavior of the user if the ticket and NFT credentials are valid, and recommending future activities to the user based on the behavior of the user.

In yet another embodiment, the present disclosure provides techniques for prioritizing users inside a venue. The techniques comprise identifying a number of tickets available inside the venue, identifying the number of NFTs available with the users if the number of tickets is less than a threshold, and prioritizing users based on the number of NFTs.

In yet another embodiment, the present disclosure provides techniques for providing rewards to the user inside a venue. The techniques comprise monitoring interactions of the user inside the venue, identifying the number of transactions made by the user inside the venue based on the number of interactions, assigning scores to users based on the number of transactions made by the user, and providing rewards to users based on scores of the users.

In yet another embodiment, the present disclosure provides techniques for creating NFTs inside a venue. The techniques comprise capturing media inside the venue, wherein the media comprises images and videos, uploading media to a server for approval by the moderator, creating NFT using media based if the media that is approved by the moderator and trading NFTs between different users created by the user.

Certain embodiments of the present disclosure relate to a method for assignment of access rights, to access a resource for a defined period of time, to at least one user device, the method comprising: rendering, via a credential server, first information associated with the resource to the user device, and receiving a request for access rights from the at least one user device in response to the rendered first information, wherein the request includes at least one of a location associated with the resource and a number of access rights requested by the user device. The method also includes extracting information from a first database based on the request received from the user device, wherein the extracted information includes a list of an unfilled number of access rights requested by the user device with parameters including at least one of the location associated with the resource, a type of access rights requested by the user device, and identifiers associated with the access rights, and assigning, via the credential server, access rights, from the list of unfilled access rights to an account associated with the user device based on the received request. Further, the method also includes assigning, by the credential server, a non-fungible token (NFT), linked with the access rights, to the account associated with the user device based on the assignment of the access rights from the list of unfilled access rights, wherein NFT is a non-fungible token in a blockchain, and acquiring, by the credential server, personal identification information of the account associated with the user device, updating the blockchain and the first database in response to the acquired personal identification information associated with the user device, and transmitting a notification to the user device, wherein the notification comprises a confirmation of assignment of the access rights and the NFT to the account associated with the user device. The method further includes verifying the validity of the access rights linked with the NFT, when the user device is requesting access to the resource, based on scanning information provided on the access rights and referencing a transaction history of the NFT in the blockchain, and transmitting at least one updated NFT and privilege to access the resource to the user device based on the verification of the access rights linked with the NFT.

Additionally, certain embodiments of the present disclosure relate to a computer-program product tangibly embodied in a non-transitory machine-readable storage medium, including instructions configured to cause a data processing apparatus to perform operations, for the assignment of access rights, to access a resource for a defined period of time, to at least one user device, including rendering, via a credential server, first information associated with the resource to the user device, and receiving a request for access rights from the at least one user device in response to the rendered first information, wherein the request includes at least one of a location associated with the resource and a number of access rights requested by the user device. The method also includes extracting information from a first database based on the request received from the user device, wherein the extracted information includes a list of the unfilled number of access rights requested by the user device with parameters including at least one of the locations associated with the resource, a type of access rights requested by the user device, and identifiers associated with the access rights, and assigning, via the credential server, access rights, from the list of unfilled access rights to an account associated with the user device based on the received request. Further, the method also includes assigning, by the credential server, a non-fungible token (NFT), linked with the access rights, to the account associated with the user device based on the assignment of the access rights from the list of unfilled access rights, wherein NFT is a non-fungible token in a blockchain, and acquiring, by the credential server, personal identification information of the account associated with the user device, updating the blockchain and the first database in response to the acquired personal identification information associated with the user device, and transmitting a notification to the user device, wherein the notification comprises a confirmation of assignment of the access rights and the NFT to the account associated with the user device. The method further includes verifying the validity of the access rights linked with the NFT, when the user device is requesting access to the resource, based on scanning information provided on the access rights and referencing a transaction history of the NFT in the blockchain, and transmitting at least one updated NFT and privilege to access the resource to the user device based on the verification of the access rights linked with the NFT.

In yet another embodiment, the method may further include transferring ownership of the NFT linked with access rights based on the information of a second user who is a receiving destination. Additionally, transferring the ownership of the NFT includes whether to give privilege related to the transfer of the ownership to a user, associated with the user device, who is at the receiving destination, and the second user is eligible as a receiving destination based on a participation score of accessing the resource or based on an index value associated with a social medial ID of the second user as an action history of the second user.

In yet another embodiment, the method may further include prioritizing the user devices for accessing privileges or other access rights based on NFTs owned by a user, associated with the user device, and past history stored in the first database.

In yet another embodiment, the method may further include the first information including presale notifications to be transmitted to one or more user devices selected from a whitelist stored in the first database.

In yet another embodiment, the method may further include comprising generating a whitelist that includes a list of approved user devices based on a comparison of the personal identification information associated with one or more user devices with corresponding information stored in the first database.

In yet another embodiment, the method may further include the first database storing at least one of historical data associated with the user devices, user preferences, user behavior, location information associated with the user device, a list of available access rights, the NFT assigned to the user device, and social media account information associated with the user device.

In yet another embodiment, the method may further include managing the personal identification information and the NFT assigned to the user device using the blockchain.

In yet another embodiment, the method may further include verifying the personal identification information acquired by the credential server by comparing with the personal identification information registered in the first database.

In yet another embodiment, the method may further include rendering the access rights associated with the NFT to the user device based on the verification of the identity of a user, associated with a user device, registered in advance, and wherein the verified information is stored in the first database.

In yet another embodiment, the method may further include the NFT issued in the blockchain in which nodes permitted by an administrator can participate, and wherein the NFTs are stored either in a non-custodial wallet accessible on the user device or in a custodial wallet accessible to NFT issuer.

In yet another embodiment, the method may further include defining a transfer method of the access rights linked to the NFT based on a smart contract of the blockchain, wherein the transfer method defines an identifier at which the user device circulates the access rights.

In yet another embodiment, the method may further include transmitting the access rights to a user, via the credential server, based on referencing a transaction history of the NFT in the blockchain and verifying the transaction history in accordance with one or more rules of a ticket transfer method linked to the NFT.

In one exemplary embodiment, the access rights linked with the NFT can be represented in data maintained at the user device or at the first database. For example, the first database or data store includes a list of identifiers for each user account associated with the user device. Each user device has an assigned access right for a resource or associating an identifier for each user or user device with an identifier of a particular access right. In some instances, indicia can be transmitted to a user device that indicates that an access right is availed. In various instances, it may be permitted or prohibited for the indicia to be transferred based on the type of NFT issued along with access rights. The indicia may be provided as part of an electronic or physical object (e.g., a right to access an event) or independently. The indicia may include an access-enabling code that can be transferred from one user device to another user device based on the type of NFT or access rights provided to the user.

Advantageously, the system enables to filter out brokers or robo users or users using API for availing access rights for an event and deprioritizing such users and withdrawing their NFTs. Further, the system provides premium NFTs to the users based on their historical information and historical NFT information. The users with premium NFTs can transfer their tickets with or without NFTs to other users.

In one exemplary embodiment, the user devices with NFT are given priority while checking in for an event based on the total value of the NFT a user own. The user device with highest value of NFT is shifted to front of the digital queue to provide privileged benefits to the users. In other words, the system is configured to rank the users based on their ownership of NFTs and also based on past history.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps and means described above may be done in various ways. For example, these techniques, blocks, steps and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

What is claimed is:

1. A method for assignment of access rights, to access a resource for a defined period of time, to at least one user device, the method comprising:
rendering, via a credential server, first information associated with the resource to the user device;
receiving a request for access rights from at least one user device in response to the rendered first information, wherein the request includes at least one of a location associated with the resource and a number of access rights requested by the user device;
extracting information from a first database based on the request received from the user device, wherein the extracted information includes a list of unfilled access rights requested by the user device with parameters including at least one of the locations associated with the resource, a type of access rights requested by the user device, and identifiers associated with the access rights;
assigning, via the credential server, access rights, from the list of unfilled access rights to an account associated with the user device based on the received request;
assigning, by the credential server, a non-fungible token (NFT), linked with the access rights, to the account associated with the user device based on the assignment of the access rights from the list of unfilled access rights, wherein NFT is a non-fungible token in a blockchain;
acquiring, by the credential server, personal identification information of the account associated with the user device;
updating the blockchain and the first database in response to the acquired personal identification information associated with the user device;
transmitting a notification to the user device, wherein the notification comprises a confirmation of assignment of the access rights and the NFT to the account associated with the user device;
verifying a validity of the access rights linked with the NFT, when the user device is requesting access to the resource, based on scanning information provided on the access rights and referencing a transaction history of the NFT in the blockchain; and
transmitting at least one updated NFT and privilege to access the resource to the user device based on the verification of the access rights linked with the NFT.

2. The method of claim 1, further comprising transferring ownership of the NFT linked with access rights based on the information of a second user who is a receiving destination.

3. The method of claim 2, wherein transferring the ownership of the NFT includes whether to give privilege related to the transfer of the ownership to a user, associated with the user device, who is at the receiving destination, and
wherein the second user is eligible as a receiving destination based on a participation score of accessing the resource or based on an index value associated with a social medial ID of the second user as an action history of the second user.

4. The method of claim 1, further comprising prioritizing the user devices for accessing privileges or other access rights based on NFTs owned by a user, associated with the user device, and past history stored in the first database.

5. The method of claim 1, wherein the first information includes presale notifications to be transmitted to one or more user devices selected from a whitelist stored in the first database.

6. The method of claim 5, further comprising generating the whitelist that includes a list of approved user devices based on a comparison of the personal identification information associated with one or more user devices with corresponding information stored in the first database.

7. The method of claim 1, wherein the first database storing at least one of historical data associated with the user devices, user preferences, user behavior, location information associated with the user device, a list of available access rights, the NFT assigned to the user device, and social media account information associated with the user device.

8. The method of claim 1, further comprising managing the personal identification information and the NFT assigned to the user device using the blockchain.

9. The method of claim 1, further comprising verifying the personal identification information acquired by the credential server by comparing it with the personal identification information registered in the first database.

10. The method of claim 9, further comprising rendering the access rights associated with the NFT to the user device based on the verification of the personal identification information of a user, associated with a user device, registered in advance, and wherein the verified information is stored in the first database.

11. The method of claim 1, wherein the NFT is issued in the blockchain in which nodes permitted by an administrator can participate, and wherein the NFTs are stored either in a non-custodial wallet accessible on the user device or in a custodial wallet accessible to NFT issuer.

12. The method of claim 1, further comprising defining a transfer method of the access rights linked to the NFT based on a smart contract of the blockchain, wherein the transfer method defines an identifier at which the user device circulates the access rights.

13. The method of claim 1, further comprising transmitting the access rights to a user, via the credential server, based on referencing a transaction history of the NFT in the blockchain and verifying the transaction history in accordance with one or more rules of a ticket transfer method linked to the NFT.

14. A computer-program product tangibly embodied in a non-transitory machine-readable storage medium, including instructions configured to cause a data processing apparatus to perform operations, for assignment of access rights, to access a resource for a defined period of time, to at least one user device, including:
rendering, via a credential server, first information associated with the resource to the user device;
receiving a request for access rights from at least one user device in response to the rendered first information, wherein the request includes at least one of a location associated with the resource and a number of access rights requested by the user device;
extracting information from a first database based on the request received from the user device, wherein the extracted information includes a list of unfilled number of access rights requested by the user device with parameters including at least one of the locations associated with the resource, a type of access rights requested by the user device, and identifiers associated with the access rights;
assigning, via the credential server, access rights, from the list of unfilled access rights to an account associated with the user device based on the received request;
assigning, by the credential server, a non-fungible token (NFT), linked with the access rights, to the account associated with the user device based on the assignment of the access rights from the list of unfilled access rights, wherein NFT is a non-fungible token in a blockchain;
acquiring, by the credential server, personal identification information of the account associated with the user device;
updating the blockchain and the first database in response to the acquired personal identification information associated with the user device;
transmitting a notification to the user device, wherein the notification comprises a confirmation of assignment of the access rights and the NFT to the account associated with the user device;
verifying validity of the access rights linked with the NFT, when the user device is requesting access for the resource, based on scanning information provided on the access rights and referencing a transaction history of the NFT in the blockchain; and
transmitting at least one updated NFT and privilege to access the resource to the user device based on the verification of the access rights linked with the NFT.

15. The computer-program product, as recited in claim 14, further comprising transferring ownership of the NFT linked with the access rights based on the information of a second user who is a receiving destination.

16. The computer-program product, as recited in claim 15, wherein transferring the ownership of the NFT includes whether or not to give privilege related to the transfer of the ownership to a second user, associated with a second user device, who is at the receiving destination, and
wherein the second user is eligible as a receiving destination based on a participation score of accessing the resource or based on an index value associated with a social medial ID of the second user as an action history of the second user.

17. The computer-program product, as recited in claim 14, further comprising prioritizing the user devices for accessing privileges or other access rights based on NFTs owned by a user, associated with the user device, and history stored in the first database.

18. The computer-program product, as recited in claim 14, further comprising verifying the personal identification information acquired by the credential server by comparing it with the personal identification information registered in the first database.

19. The computer-program product, as recited in claim 14, further comprising storing, in the first database, at least one of historical data associated with the user devices, user preferences, user behavior, location information associated with the user device, a list of available access rights, the NFT assigned to the user device, and social media account information associated with the user device.

20. The computer-program product, as recited in claim 14, wherein the NFT is issued in the blockchain in which nodes permitted by an administrator can participate, and wherein the NFTs are stored either in a non-custodial wallet accessible on the user device or in a custodial wallet accessible to NFT issuer.
